(19) United States
(12) Patent Application Publication
(10) Pub. No.: US 2017/0170885 A1
(43) Pub. Date: Jun. 15, 2017

(54) BEAMFORMING CHANNEL SMOOTHING

(71) Applicants: Qinghua Li, San Ramon, CA (US); Xiaogang Chen, Beijing (CN); Xintian Lin, Mountain View, CA (US); Yuan Zhu, Beijing (CN); Assaf Gurevitz, Ramat Hasharon (IL); Uri Perlmutter, Holon (IL)

(72) Inventors: Qinghua Li, San Ramon, CA (US); Xiaogang Chen, Beijing (CN); Xintian Lin, Mountain View, CA (US); Yuan Zhu, Beijing (CN); Assaf Gurevitz, Ramat Hasharon (IL); Uri Perlmutter, Holon (IL)

(21) Appl. No.: 15/283,383

(22) Filed: Oct. 1, 2016

Related U.S. Application Data
(60) Provisional application No. 62/265,354, filed on Dec. 9, 2015.
(60) Provisional application No. 62/268,939, filed on Dec. 17, 2015.

(51) Int. Cl. H04B 7/04; H04W 72/04; H04W 28/02

(52) U.S. Cl. CPC H04B 7/0456; H04W 28/0236; H04W 72/0453

(57) ABSTRACT

This disclosure describes methods, apparatus, and systems related to applying channel smoothing to beamformed vectors in wireless communications between a transmitter device and a receiver device. In a first aspect, a device is disclosed that identifies disruptions between at least two first beamforming vectors on adjacent frequencies in a communication channel between the device and a first device of a plurality of user devices. The device determines one or more second beamforming vectors proximate to the identified disruption. The device utilizes the one or more second beamforming vectors to smooth the communication channel between the device and the first device of the plurality of user devices.

### CROSS-REFERENCE TO RELATED APPLICATIONS

This application claims the benefit of U.S. Provisional Application No. 62/268,354 filed Dec. 9, 2015 and of U.S. Provisional Application No. 62/268,939 filed Dec. 17, 2015, the disclosures of which are incorporated herein by reference in their entireties.

### TECHNICAL FIELD

This disclosure generally relates to systems and methods for wireless communications and, more particularly, enhancing Wi-Fi performance for wireless devices utilizing beamforming.

### BACKGROUND

Wireless devices are becoming widely prevalent and utilize beamforming to increase signal power. Current beamforming techniques however, result in channel disruptions thereby degrading signal performance due to lack of channel smoothing.

### BRIEF DESCRIPTION OF THE DRAWINGS

FIG. 1 depicts a network diagram illustrating an example network environment, according to some example embodiments of the present disclosure, according to one or more example embodiments of the disclosure.

FIG. 2 depicts an illustrative schematic diagram of beamforming vector smoothing, in accordance with one or more example embodiments of the present disclosure.

FIG. 3 depicts an illustrative schematic diagram of beamforming vector smoothing, in accordance with one or more example embodiments of the present disclosure.

FIG. 4 depicts an illustrative schematic diagram of beamforming vector smoothing, in accordance with one or more example embodiments of the present disclosure.

FIG. 5 depicts an illustrative schematic diagram of piecewise continuous beamforming, in accordance with one or more example embodiments of the present disclosure.

FIG. 6 depicts an illustrative schematic diagram of a continuous beamforming weights across tones, in accordance with one or more example embodiments of the present disclosure.

FIG. 7 illustrates a flow diagram of illustrative process for applying beamforming vector smoothing to beamformed channels in accordance with one or more embodiments of the disclosure.

FIG. 8 illustrates a flow diagram of illustrative process for applying beamforming vector smoothing to beamformed channels in accordance with one or more embodiments of the disclosure.

FIG. 9 illustrates a functional diagram of an example communication station that may be suitable for use as a user device, in accordance with one or more example embodiments of the disclosure.

FIG. 10 is a block diagram of an example machine upon which any of one or more techniques (e.g., methods) may be performed, in accordance with one or more embodiments of the disclosure.

### DETAILED DESCRIPTION

Example embodiments described herein provide certain systems, methods, and devices, for applying channel smoothing to beamformed channels in wireless communications between a transmitter device and a receiver device.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Transmit beamforming is a powerful technique that boosts the received signal power in network devices. However, beamforming weights across a particular frequency may not be smooth due to the effect of rank reversal. The rank reversal may happen between two eigen-modes of a multiple-input and multiple-output (MIMO) channel. As a result of rank reversal, the stronger mode of previous subcarriers becomes the weaker mode at the current subcarrier. When the strongest mode of each subcarrier is used for the beamforming, the receiver device sees a disruption at the subcarrier where the mode switches. Thus, because of the rank reversal, the beamformed channel may not be smooth across a frequency even though the propagation channels are continuous by themselves. Because of the disruptions on the beamformed channel, it is difficult to apply smoothing to the channel estimates at the receiver device. As a result, the unsmoothed channel estimates may degrade performance (e.g., by 1-2 dB). Besides rank reversal, disruptions may also be based on high frequency selectivity of the beamformed channel. The high frequency selectivity of the beamformed channel may be based at least in part on occasional fast changes of the beamformed vector across frequency. The methods disclosed herein may be applied to solve both types of disruptions (for example rank reversal and high frequency selectivity).

Beamforming can boost received signal power, or increase the power spectral density, by transmitting signals from an antenna array to at least one receiver of a user device in a Multiple Input Multiple Output (MIMO) network of user devices. One objective in a MIMO network of devices, especially in densely populated MIMO networks, is to increase the received signal power of signal at a receiver of an intended user device (a receiver of a device that a signal is intentionally transmitted to) and reduce any interference experienced by a receiver of an unintended device (a receiver of a device that unintentionally overhears the signal) that may be experienced as a result of receiving the signal.

Achieving a high signal power at a receiver of an intended user device, will minimize the interference experienced by an unintended user device. This may be accomplished by a transmitter transmitting a single on one or more antennas, with different amplitudes and phases (beamforming), so that the transmitted signals arrive constructively at the receiver of the intended user device, and arrive at the receiver of the unintended user device destructively. Because the signals arrive at the receiver of the unintended device destructively, the receiver of the unintended user device will treat the received signals as noise and may disregard (filter the received signals with an application specific integrated circuit (ASIC)) the received signals.

One way to ensure that a high signal power is received at the receiver of the intended device while minimizing the interference at the receiver of the unintended device may be to apply beamforming vectors and weights associated with the beamforming vectors to the signals. Each beamforming vector may represent a mode of operation of the transmitter and the intended devices. In particular, the beamforming vectors used to transmit the signals from the transmitter to the intended device correspond to a configuration of the transmitter, that is the transmitter may be configured to transmit one or more first signals on a first set of antennas of an antenna array using a second beamforming vector over a second range of frequencies (a second mode). Each beamforming vector may be a digital representation of the signals, and the digital representation of the signals may be modulated by a carrier wave such that a corresponding analog subcarrier wave is generated. In particular, each entry (or element) of the beamforming vector may correspond to a frequency, and thus a corresponding subcarrier wave at the frequency. Because the transmitter may be in first configuration to transmit the one or more first signals using a first beamforming vector, and may be in a second configuration to transmit the one or more second signals the transmitter may be said to be operating in a first and second mode.

The beamforming vectors may be determined based at least in part on an estimate of the channel impulse response between the transmitter and the intended device. In particular, the transmitter and the intended device may determine the estimate of the channel impulse either explicitly and/or implicitly. For instance, the intended device may explicitly determine the estimate of the channel impulse response in response to receiving one or more training symbols, from the transmitter and comparing the received training symbols to a known set of one or more symbols stored in both the transmitter and the intended device. The transmitter may implicitly determine the estimate of the channel impulse response between itself and the intended user device based on the estimate of the channel impulse response that is feedback (sent from the intended device to the transmitter) to the transmitter. Because both the transmitter and the intended device is known the estimate of the channel impulse response, the transmitter and/or intended device may determine the beamforming vectors by determining a singular value decomposition (SVD) of the estimate of the channel impulse response. In particular, the estimate of the channel impulse response may be decomposed (factored) into two unitary matrices and a rectangular diagonal matrix.

As mentioned above, the estimate of the channel impulse response may be decomposed (factored) into two unitary square matrices and a rectangular diagonal matrix. The columns of the two unitary square matrices are orthonormal eigenvectors of one of the unitary square matrices may be used as the beamforming vectors, and the eigenvectors, and the eigenvectors of the other unitary square matrix may be used by an intended device to determine the content of a signal sent by the transmitter. In particular, the intended device may multiply a signal received from the transmitter by the other unitary matrix to recover (determine) the content (data) in the signal. Because the vectors in the unitary square matrices are eigenvectors when different beamforming vectors are used and therefore different modes are used, by the transmitter the different modes may be referred to as eigen-modes, of a MIMO channel. As explained above, the transmitter may use different beamforming vectors to increase the strength (gain) of the received signal at the intended device, thus the mode that ensures that the gain of the received signal is maximized will be used.

As the transmitter switches from using one beamforming vector to another beamforming vector when the intended device receives signals that were sent from the transmitter using the different vectors, the intended device may determine that there is a disruption in the strength of the received signal. The process of switching from one beamforming vector to another beamforming vector may be referred to as a rank reversal. The switch may also occur due to disruptions on a high frequency selective channel. For example the intended device, and more specifically a receiver of the intended device, may receive a first signal transmitted by the transmitter using a first beamforming vector over a first range of frequencies, because the first beamforming vector is the beamforming vector that maximizes the received signal strength of the firs signal over the first range of frequencies. But the receiver may receive a second signal from the transmitter that was transmitted with a second beamforming vector, over a second range of frequencies, because the second beamforming vector is the beamforming vector that maximizes the received signal strength of the second signal over the second range of frequencies. As a result of the transmitter using two different beamforming vectors, without notifying the receiver ahead of time, the receiver may determine that there is a range of frequencies between the highest frequency in the first range of frequencies (assuming that the frequencies in the first range of frequencies are less than the frequencies in the first range of frequencies are less than the frequencies in the second range of frequencies) and the lowest frequency in the second range of frequencies. This may occur because the transmitter and/or receiver may have determined that the best frequencies (frequencies over which there are less disruptions on the channel or frequency selective channel fading) to transmit the first and second beamforming vectors over are the first frequency range and the second frequency range, wherein there are no overlapping frequencies between the first range of frequencies and the second range of frequencies. Accordingly, the receiver may determine one or more new beamforming vectors that may be transmitted over the range of frequencies between the highest frequency in the first range of frequencies and the lowest frequency in the second range of frequencies. The one or more new beamforming vectors may be used by the transmitter to make use of unused frequencies and may also be used by the transmitter or receiver to determine an updated estimate of the channel impulse response as explained below. In some embodiments the transmitter may determine the one or more new beamforming vectors. The process of determining the one or more new beamforming vectors may be referred to as smoothing.

Because of rank reversal, the beamformed channel may not be smooth across a group of frequencies even though the propagation channels (channels over which signals sent from a transmitter to a receiver) are continuous. Because the beamforming vectors can be used to estimate the channel impulse response, when a rank reversal occurs it may be difficult for the receiver to apply smoothing to a channel impulse response estimate. The consequences of a receiver using an unsmooth estimate of the channel impulse response may be a reduction in received signal strength (gain) between 1 and 2 decibels (dB) as mentioned above. For example, in some embodiments of the Institute of Electrical and Electronics Engineers (IEEE) Wireless Fidelity (Wi-Fi) standards 802.11 n/ac when a receiver applies smoothing the receiver may experience a gain of 2 dB in received signal strength. The receiver may apply smoothing to a signal corresponding to a legacy portion of a IEEE 802.11 n/ac packet.

In some embodiments the receiver may smoothen the estimate of the channel impulse response by determining a plurality of frequency bands (subbands) within which smoothening may be applied. For example, the receiver may divide the estimate of the channel impulse response into a plurality of estimates each of which corresponds to each of the plurality of subbands, and may determine if a rank reversal or disruption in the channel has occurred in any of the plurality of estimates. The receiver may determine that if a rank reversal or disruption in the channel has not occurred, it will not switch modes of operation (use a different beamforming vector), and that if a rank reversal has occurred that it should smoothen the estimate of the channel impulse response within the corresponding subband.

The beamformed channel may comprise beamforming vector(s) and the propagation channel. In some embodiments, the beamforming vector(s) can be smoothed across frequency the propagation channel may not be able to be smoothed. In general, the propagation channel is smooth. The disruptions of the beamformed channel are due to the beamforming vector(s). The beamforming vectors may be a part of a beamforming matrix wherein the beamforming vectors form the columns of the beamforming matrix.

Example embodiments of the present disclosure relate to systems, methods, and devices for enhancing Wi-Fi performance by applying channel smoothing to beamformed channels in wireless communications between a transmitter device device and a receiver device. In a first aspect, a beamforming channel smoothing system may synthesize smooth beamforming vectors utilizing the continuous beamforming vectors of the two eigen-modes where rank reversal occurs. The rank reversal of two eigen-modes is identified. Then, one or more beamforming vectors may be determined based on the identified rank reversal. The one or more beamforming vectors may be utilized for beamforming vector smoothing by the transmitter device device. In another aspect, a channel bandwidth is divided into one or more subbands. Each of the one or more subbands includes a continuous beamforming vector. Channel smoothing may be performed on channel estimates within each of the one or more subbands by the receiver device. The disclosed systems and methods can thus achieve additional signal gain from the smoothing of beamformed channels.

In example embodiments, a beamforming channel smoothing system may utilize two schemes. The first scheme may apply smoothing at the disruptive positions where rank reversals or high frequency selectivity occur. The second scheme may divide a channel bandwidth into subbands. Within each subband, beamforming weights do not change with rank reversal or high frequency selectivity such that channel continuity is maintained. Across subbands, beamforming weights can change disruptively. At the receiver device side, channel smoothing is applied within each subband for boosting the performance.

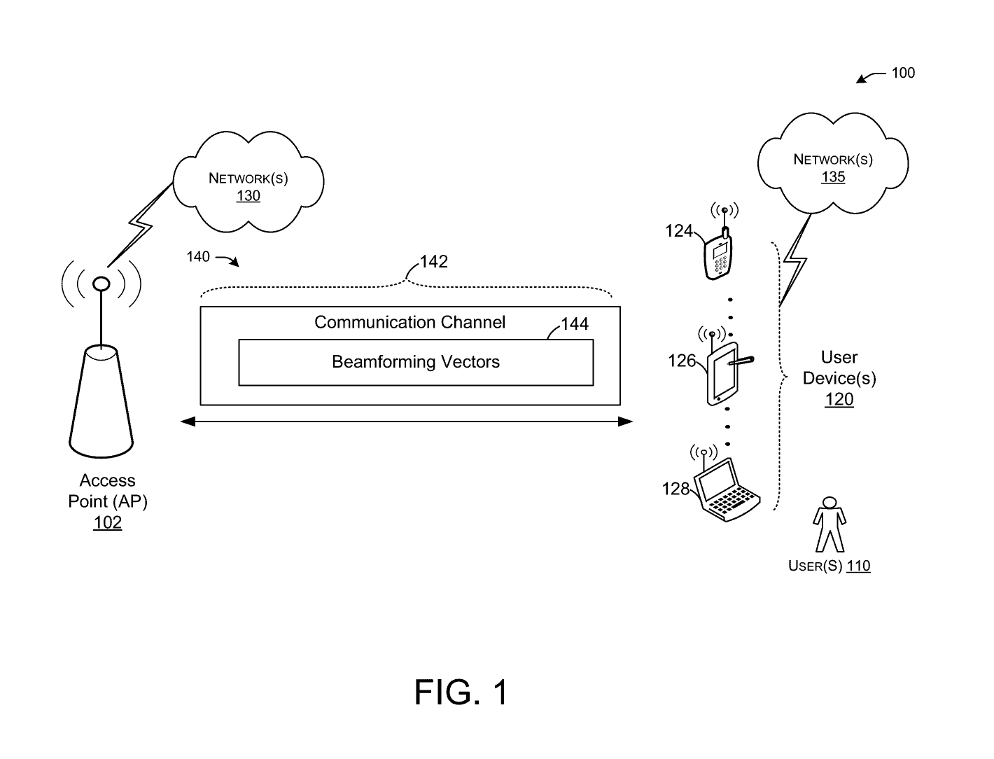

FIG. 1 is a diagram illustrating an example network environment, according to some example embodiments of the present disclosure. Wireless network 100 may include one or more devices 120 and one or more access point(s) (AP) 102, which may communicate in accordance with IEEE 802.11 communication standards, including IEEE 802.11ax. The device(s) 120 may be mobile devices that are non-stationary and do not have fixed locations.

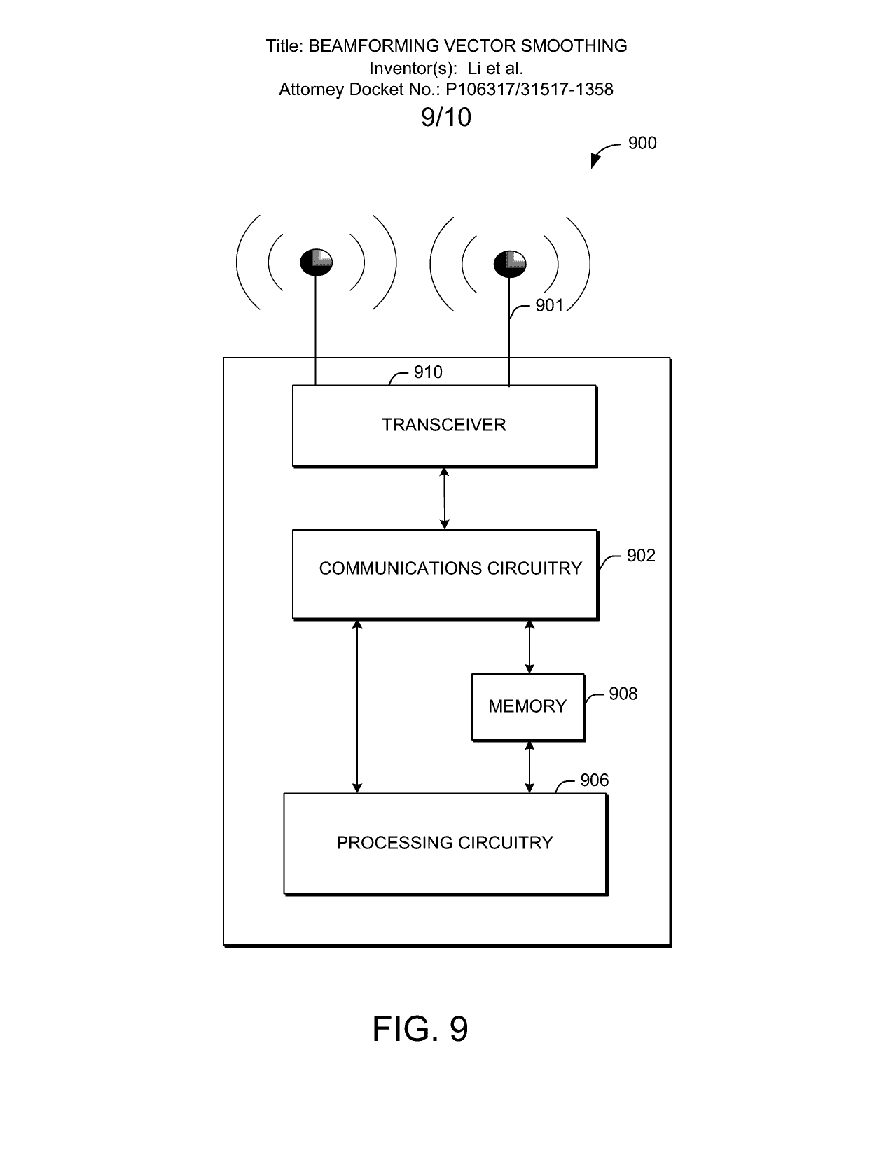

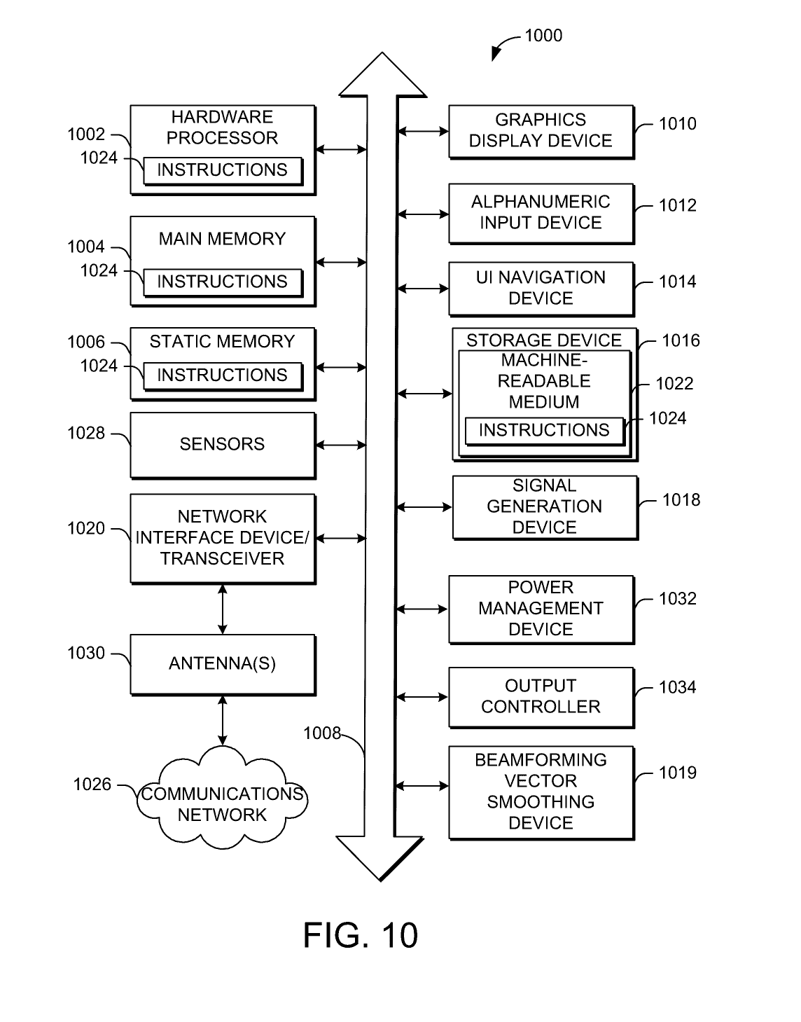

In some embodiments, the user devices 120 and AP 102 may include one or more computer systems similar to that of the functional diagram of FIG. 9 and/or the example machine/system of FIG. 10.

One or more illustrative user device(s) 120 may be operable by one or more user(s) 110. The user device(s) 120 (e.g., 124, 126, or 128) may include any suitable processor-driven user device including, but not limited to, a desktop user device, a laptop user device, a server, a router, a switch, an access point, a smartphone, a tablet, wearable wireless device (e.g., bracelet, watch, glasses, ring, etc.) and so forth.

Any of the user device(s) 120 (e.g., user devices 124, 126, 128), and AP 102 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128), and AP 102 may include one or more communications antennae. Communications antenna may be any suitable type of antenna corresponding to the communications protocols used by the user device(s) 120 (e.g., user devices 124, 126 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, or the like. The communications antenna may be communicatively coupled to a radio component to transmit and/or receive signals, such as communications signals to and/or from the user devices 120.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n), 5 GHz channels (e.g. 802.11n, 802.11ac), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver device and baseband suitable for communicating via the communications protocols. The radio component may further include a low noise amplifier (LNA), additional signal amplifiers, an analog-to-digital (A/D) converter, one or more buffers, and digital baseband.

Typically, when an AP (e.g., AP 102) establishes communication with one or more user devices 120 (e.g., user devices 124, 126, and/or 128), the AP may communicate in the downlink direction by sending data frames. The data frames may be preceded by one or more preambles that may be part of one or more headers. These preambles may be used to allow the user device to detect a new incoming data frame from the AP. A preamble may be a signal used in network communications to synchronize transmission timing between two or more devices (e.g., between the APs and user devices). Portions of the data frames and preambles may be beamformed. In some embodiments a data frame may be stored in a memory as an array (vector), wherein each entry of the vectors corresponds to a sample of a continuous signal generated by processor (e.g., Hardware Processor 902) executing computer-executable instructions causing the processor to estimate (measure) a channel impulse response. The vector may comprise real values or complex values. The dimensions of the vector may be based at least in part on the number of antennas associated with an AP. For example, AP 102 may have four antennas, as a result the vector may comprise four entries resulting in a vector with a dimension of four rows and one column. In general the vector may comprise N rows and one column resulting in a N×1 vector. The vector may be expressed as \vec{x} and the values (real or complex values) of the entries of the vector may be represented by “R” for real values and “C” for complex values. Thus a complex valued N dimensional vector may be expressed as \vec{x} ∈C^{N×1}. Each entry of the vector may correspond to a signal, associated with a complex number, transmitted by an antenna on AP 102. Returning to the example above \vec{x} may be expressed as

$$\vec{x} = \begin{matrix}{a}_{0} + {jb}_{0} \\ ⋮ \\ {a}_{4} + {jb}_{4}\end{matrix} ,$$

and a₀+jb₀. . . a₄+jb₄ may correspond to a signal transmitted from antennas 1 . . . 4 on the AP. In some embodiments, the data frames may comprise one or more legacy IEEE 802.11ax fields that may be beamformed by beamforming vectors.

An estimate of channels, between each antenna on AP 102 and each antenna on each of user device(s) 120 may be known to AP 102, and each of user devices (s) 120. This may be referred to as full channel state information. That is, when AP 102 and each of user device(s) 120 both know the estimate of the channels AP 102 and each of user device(s) 120 may be said to have full channel state information. In particular, the channels between the antennas on AP 102 and each of user device(s) 120 may be characterized by a channel impulse response denoted by H, and an estimate of the channel impulse response may be determined by AP 102 or each of user device(s) 120 for each channel between AP 102 and each of user device(s) 120. For example, AP 102 may have four antennas and user device 128 may have two antennas therefore, there may comprise two rows, representing the receiving antennas, and four columns representing the transmitting antennas.

In some embodiments, AP 102 may determine the estimate of the channel impulse response to each of user device(s) 120. In other embodiments, user device(s) 120 may determine the estimate of the channel impulse response and transmit the estimate of the channel impulse response to AP 102. In the embodiments in which AP 102 and user device(s) 120 have full channel state information, AP 102 or user device(s) 120 may determine that the estimate of the channel impulse response may be a matrix comprised of M rows, where M may be an y natural number, and represents the number of antennas associated with a user devices. For instance, user device 128 may be a laptop, or computer in general, with M=2 antennas. The columns of the estimate of the channel impulse response represent the number of transmitting antennas associated with AP 102. For instances, the estimate of the channel impulse response may comprise N columns, where N may be any natural number, for example, N=4, and N may correspond to the number of antennas associated with AP 102. The estimate of the channel impulse response may be denoted as R.

The estimate of the channel impulse response may correspond to an estimate of the channel impulse response between the N antennas associated with AP 102 and M antennas associated with a user device (e.g., user device 128). Because AP 102 and user device(s) 120 know Ĥ for each channel, corresponding to the channel impulse responses, between each of the antennas between AP 102 and each of the antennas of user device(s) 120. In particular, one or more processors associated with AP 102 and/or one or more processors associated with each of user device(s) 120 may decompose (factor) Ĥ into two unitary matrices Û and \hat{V} and a diagonal matrix \hat{Σ}. Unitary matrix Û may comprise complex valued entries and may comprise at least two rows and two columns. The columns of Û are eigenvectors, therefore Û may be stored in memory as an array (vector) of eigenvectors. In particular, Û may be expressed as Û=[\vec{u₁}, \vec{u₂}, . . . , \vec{u_{M}}], where M is the number of antennas associated with a user device and the length or dimension of an eigenvector \vec{uₖ}, for k=1, 2, . . . , M, may be equal to M. Û may be a complex valued square unitary matrix. In other words, each \vec{uₖ} may be expressed as

$$\vec{{u}_{k}} = \begin{matrix}{u}_{1 k} \\ ⋮ \\ {u}_{Mk}\end{matrix}$$

for k=1, 2, 3, . . . , M. Eigenvectors ii may be used by a user device of user device(s) 120 to determine the content of a data frame, sent from AP 102 to user device of user device(s) 120, as explained below. Eigenvectors \vec{uₖ} may be referred to as receiver eigenbeamforming vectors.

Unitary matrix \hat{V} may comprise complex valued entries and may comprise at least two rows and two columns. The columns of Vare eigenvectors, therefore \hat{V} may be stored in memory as an array (vector) of eigenvectors. In particular, \hat{V} may be expressed as \hat{V}=[\vec{v₁}, \vec{v₂}, . . . , \vec{v_{N}}], where N is the number of antennas associated with a user device and the length or dimension of an eigenvector \vec{vᵢ}, for i=1, 2, . . . , N, may be equal to N. \hat{V} may be a complex valued square unitary matrix. In other words, each \vec{vᵢ} may be expressed as

$$\vec{{v}_{1}} = \begin{matrix}{v}_{1 k} \\ ⋮ \\ {v}_{Nk}\end{matrix}$$

for i=1, 2, 3, . . . , N. Eigenvectors w, may be used by a user device of user device(s) 120 to beamform a data frame, sent from AP 102 to a user device of user device(s) 120, as explained below. Eigenvectors \vec{vₖ} may be referred to as transmitter eigenbeamforming vectors.

The diagonal matrix \hat{Σ} may comprise non-negative singular value entries along the diagonal of transmitter eigenbeamforming vectors, and zeros in the remaining entries of \hat{Σ}. The diagonal matrix \hat{Σ} may also be referred to as a singular value matrix, and may be expressed as

$$\hat{Σ} = \begin{matrix}{σ}_{1} & 0 & … & 0 \\ 0 & {σ}_{2} & & 0 \\ ⋮ & & ⋱ & ⋮ \\ 0 & & & {σ}_{l}\end{matrix} ,$$

where l=1, 2, . . . , N. The diagonal matrix \hat{Σ} may also be referred to as a singular value matrix, and may be expressed as \hat{Σ}=diag (σ₁, σ₂, . . . , σₗ) for l=1, 2, 3, . . . , N. The diagonal matrix \hat{Σ} may comprise M rows and N columns. The entries of \hat{Σ} may be used by AP 102 to determine the amount of power that should be applied to each of the N antennas when transmitting beamformed data frames to a user device, of the user devices 120. The entries may be referred to as the beamforming gain. In some embodiments, a power adaptation matrix may be determined, and the power adaptation matrix may be a diagonal matrix comprising quantized power values, wherein the quantized power values correspond to the transmission power levels for each transmitter eigenbeamforming vector. The entries of \hat{Σ} may have the property of σ₁>σ₂> . . . >σₗ, for l=1, 2, . . . , N, which ensures that the beamforming gain with the greatest value is always associated with the transmitter eigenbeamforming vector that corresponds to the greatest receive power gain. For example, transmitter eigenbeamforming vector \vec{v₁} will always be transmitted with a beamforming gain σ₁. When a rank reversal, or disruption on a channel occurs, perhaps due to a user device moving, and thus the channel impulse response between the AP and the user device changing, the transmitter eigenbeamforming vector \vec{v₂} may be used in place of \vec{v₁}, as a result \vec{v₂} will be transmitted with a beamforming game σ₁. The beamforming gains may be applied to different transmitter eigenbeamforming vectors as the channel impulse response changes as a function of frequency which may be due to perturbations of the channel caused by movement of a user device, obstacles between the user device and access point, or possibly interference from other devices not using an eigenbeamforming transmission scheme as disclosed herein.

The decomposed estimate of the channel impulse response may be expressed as Ĥ=Û\hat{Σ}\hat{V}. Thus, the estimate of the channel impulse response may be factored by AP 102 or user devices(s) 120 into a matrix receiver eigenbeamforming matrix Û, beamforming gain matrix \hat{Σ}, and the conjugate transmitter eigenbeamforming \hat{V}, wherein a conjugate transpose is denoted by H^{H}.

AP 102 and user device(s) 120 may determine that the entries of Û are based at least in part on the estimate of the channel impulse response. The eigenvectors of ĤĤ^{H} are equal to the columns of Û. In particular, each \vec{uₖ} for k=1, 2, . . . , M is equal to an eigenvectors of ĤĤ^{H}. Similarly, each \vec{vₖ} for l=1, 2, . . . , N is equal to an eigenvectors of Ĥ^{H}Ĥ. AP 102 and user device(s) 120 may determine that the entries of \hat{Σ} are based at least in part on the estimate of the channel impulse response. In particular, each σₗ for l=1, 2, . . . , N, is based at least in part on the eigenvalues of ĤĤ^{H}.

When AP 102 sends data frame to user device(s) 120 AP 102 may beamform all or at least a portion of the data frame using transmitter eigenbeamforming vectors \vec{vₖ} for k=1, 2, . . . , N. In particular, a processor and/or an application specific integrated circuit (ASIC), may determine a matrix multiplication of \hat{V} and a data frame \vec{x}, to generate a beamformed data frame \tilde{x}=\hat{V}\vec{x}, where \tilde{x} is a vector with the same dimension as \vec{x}. AP 102 may transmit the beamformed vector \tilde{x} to user device(s) 120 when AP 102 needs to transmit a data frame (e.g., \vec{x}). When user device(s) 120 receive the data frame after it has been transmitted through a channel between one or more antennas on AP 102 and user device(s) 120, user device(s) 120 may receive a different version of the data frame because the channel impulse response may perturb the transmitted data frame. Accordingly, user device(s) 120 may receive a perturbed version of the data frame denoted by a vector \vec{y} which is equal to the matrix multiplication of the channel impulse response H and the data frame \vec{x}. In particular, \vec{y} may be expressed as \vec{y}=H\vec{x}+\vec{n}, where \vec{n} is a vector comprising noise information about the channel impulse response. Because the user device(s) 120 determine an estimate of the channel impulse response, the user device(s) 120 may use the received data frame and the decomposed estimate of the channel impulse response to determine a version of the transmitted data frame. In particular, user device(s) 120 may multiply Û^{H} by \vec{y} resulting in the following expression Û^{H}\vec{y}=\hat{Σ}\hat{V}^{H}\vec{x}+\vec{n}. User device(s) 120 may then multiply Û^{H}\vec{y} by \hat{Σ}^{H} and \hat{V} in order to determine an estimate of the transmitted data frame \vec{x} (\vec{x}=\vec{V}\vec{Σ}⁻¹Û^{H}\vec{y}−\hat{V}\hat{Σ}⁻¹\vec{n}). The user device(s) 120 may comprise one or more hardware filters implemented as one or more ASICs that may filter out the noise term \hat{V}\vec{Σ}⁻¹\vec{n}, so that user devices(s) 120, and/or AP 120, may determine the transmitted data frame by computing \hat{V}\hat{Σ}⁻¹Û^{H}\vec{y}.

The channel impulse response may be frequency selective (i.e., the bandwidth of a signal transmitted through the channel is greater than the coherence bandwidth of the channel) and because the channel impulse response may be decomposed into a receiver eigenbeamforming matrix Û, beamforming gain matrix \hat{Σ}, and a transmitter eigenbeamforming matrix Û, \hat{Σ}, and \hat{V} may be frequency selective as well. The coherence bandwidth may be a range of frequencies over which the channel impulse response may be flat, or the maximum bandwidth or frequency interval over which two frequencies of a signal are likely to experience comparable or correlated amplitude fading. Accordingly, some receiver and transmitter eigenbeamforming vectors may be used to beamform a data frame to combat the frequency selectiveness of the channel impulse response. For example, AP 102 may transmit a portion of data frame \vec{x} using transmitter eigenbeamforming vector \vec{v₁} over a first range of frequencies, and may transmit another portion of \vec{x} using another transmitter eigenbeamforming vector \vec{v₂} over a second range of frequencies because \vec{v₁} will ensure that \vec{x} is received at one or more antennas of user device(s) 120 with the greatest gain over the first range of frequencies and \vec{v₂} will ensure that \vec{x} is received at one or more antennas of user device(s) 120 with the greatest gain over the second range of frequencies. For instance, the channel impulse response at a first frequency f₁ may be H(f₁) and the channel impulse response at a second frequency f₂ may be H(f₂), and user device(s) 120 or AP 102 may determine Û, \hat{Σ}, and \hat{V} for f₁ and f₂, where f₂>f₁ for an estimate of H(f₁) and H(f₂). That is, user device(s) 120 and/or AP 102 may determine that

Ĥ(f₁)=Û(f₁)\hat{Σ}(f₁)\hat{V}^{H}(f₁) and Ĥ(f₂)=Û(f₂)\hat{Σ}(f₂)\hat{V}^{H}(f₂).

The user device(s) 120 and/or AP 102 may then determine the eigenbeamforming vectors of \hat{V}(f₁) and \hat{V}(f₂) to determine if a rank reversal has occurred of if there channel impulse response experiences perturbations at f₁ and/or f₂. Beamforming gain

\hat{Σ}(f₁)=diag(σ₁(f₁), σ₂(f₁), . . . , σ_{N}(f₁)) and beamforming gain \hat{Σ}(f₂)=diag(σ₁(f₂), σ₂(f₂), . . . , σ_{N}(f₂)) transmitter eigenbeamforming vectors of \hat{V}(f₁) are equal [\vec{v₁}(f₁), \vec{v₂}(f₁), . . . , \vec{v_{N}}(f₁)] and \hat{V}(f₂) are equal [\vec{v₁}(f₂), \vec{v₂}(f₂), . . . , \vec{v_{N}}(f₂)]. User device(s) 120 may compare the beamforming gains and the transmitter eigenbeamforming vectors at f₁ and f₂, to determine if a rank reversal or perturbation in the channel impulse response has occurred at f₁ and f₂. In particular, user device(s) 120 may determine that a rank reversal perturbation in the channel impulse response has occurred when a transmitter eigenbeamforming vector at f₂ (e.g., \vec{vⱼ}(f₂)), wherein j=1, . . . , N) is equal to a transmitter eigenbeamforming vector at f₂ (e.g., \vec{vₖ}(f₂)), wherein k=1, . . . , N, and j≠k), and the beamforming gain associated with \vec{vⱼ}(f₂) (e.g., σⱼ(f₂)) is greater than the beamforming gain associated with \vec{vₖ}(f₂) (e.g., σₖ(f₂)). For example, AP 102 may have four antennas, and therefore four transmitter eigenbeamforming vectors \vec{v₁}(f), \vec{v₂}(f), \vec{v₃}(f), \vec{v₄}(f) may be used to beamform a data frame transmitted by AP 102, and each of the transmitter eigenbeamforming vectors may be associated with beamforming gains σ₁(f), σ₂(f), σ₃(f), σ₄(f) respectively. User device(s) 120 and/or AP 102 may determine the transmitter eigenbeamforming vectors and beamforming gains by estimating the channel impulse response for a range of frequencies. User device(s) 120 and/or AP 102 may determine that beamforming gains σ₁(f) is greater than each of beamforming gains σ₂(f), σ₃(f), σ₄(f) and therefore transmitter eigenbeamforming vector \vec{v₁}(f) is the strongest (eigenbeamforming vector with the greatest gain) transmitter eigenbeamforming vector over a first range of frequencies (for example f₁ to f₂), and that at frequency f₂ transmitter eigenbeamforming vector \vec{v₁}(f₂) is equal to \vec{v₂}(f′₂), wherein f′₂=f₂−Δf, an Δf is any positive real number. The frequency f′₂>f₁ and beamforming gain σ₁(f₂) is greater than each of beamforming gains σ₂(f₂), σ₃(f₂), σ₄(f₂). User device(s) 120 and/or AP 102 may also determine at frequency f₂, that σ₂(f₂) is greater than each of beamforming gains σ₁(f₂), σ₃(f₂), σ₄(f₂) thereby making \vec{v₂}(f₂) the strongest transmitter eigenbeamforming vector at frequency f₂. The user device(s) 120 and/or AP 102 may determine that a rank reversal or channel impulse response perturbation has occurred at frequency f₂ and σ₂(f₂) is greater than each of beamforming gains σ₁(f₂), σ₃(f₂), σ₄(f₂) and transmitter eigenbeamforming vector \vec{v₂}(f₂) is the strongest transmitter eigenbeamforming vector, over a second range of frequencies (for example f₂to f₃). User device(s) 120 and/or AP 102 may determine that transmitter eigenbeamforming vectors \vec{v₃}(f) and \vec{v₄}(f) maybe the strongest transmitter eigenbeamforming vectors over a third and fourth range of frequencies respectively.

The beamforming gains at the frequency where a rank reversal or channel impulse response perturbation occurs may be approximately equal to the same number. For instance, returning the to the example above, even though σ₁(f₂)<σ₂(f₂) at frequency f₂, beamforming gain σ₁(f₂) may be equal to a first number on the real number line (for example, σ₁(f₂)=m), beamforming gain σ₂(f₂) may be equal to a second number line (for example σ₂(f₂)=n), and |m−n|<L, where L∈ (0,1) (that is a real number between 0 and 1). In general, the beamforming gains are approximately equal to the same number, at a rank reversal or channel impulse response perturbation frequency, regardless of whether the transmitter eigenbeamforming vector before or after the rank reversal or channel impulse response perturbation is used to beamform a portion of a data frame. The beamforming gains are approximately equal to the same number if a linear combination of the transmitter eigenbeamforming vectors, before and after the rank reversal or channel impulse response perturbation, are used to beamform a portion of the data frame.

Rank reversal or channel impulse response perturbation may be determined by user device(s) 120 or AP 102 by determining whether a first transmitter eigenbeamforming vector is used in a first frequency range, and a second transmitter eigenbeamforming vector is used in a second frequency range, wherein the beamforming gain associated with the second transmitter eigenbeamforming vector is less than the beamforming gain associated with the first transmitter eigenbeamforming vector. In some embodiments, user device(s) 120 or AP 102 may determine a rank reversal or channel impulse response perturbation has occurred by determining an absolute value of an autocorrelation of a transmitter eigenbeamforming vector at a first and second frequency. For instance, user device(s) 120 may determine the autocorrelation of the transmitter eigenbeamforming vector by taking a transpose of a transmitter eigenbeamforming vector at a frequency, f, and may multiply the transposed transmitter eigenbeamforming vector by the same transmitter eigenbeamforming vector at a frequency, f+1, and determine the absolute value of the resulting product. User device(s) 120 or AP 102 may then determine whether the autocorrelation of the eigenbeamforming vector is less than a predetermined number (threshold) on the real number line between 0 and 1. User device(s) 120 or AP 102 may determine rank reversal or channel impulse perturbation has occurred when the autocorrelation of the transmitter eigenbeamforming vector is less than the predetermined number because the autocorrelation measures similar the transmitter eigenbeamforming vector is to itself. As the value of the autocorrelation of the transmitter beamforming approaches 0, the transmitter eigenbeamforming vector is less similar to itself and is more similar to another transmitter eigenbeamforming vector. This may be expressed as ρ(f)=|\vec{v′ᵢ}(f)\vec{vᵢ}(f+1)1, where ρ(f) is equal to the absolute value of the autocorrelation of transmitter eigenbeamforming vector \vec{vᵢ}(f).

In other embodiments, a rank reversal may be determined by comparing an absolute value of a cross correlation of two transmitter eigenbeamforming vectors. User device(s) 120 or AP 102 may determine an absolute value of the cross correlation of a transmitter eigenbeamforming vector \vec{vᵢ}(f), at a frequency f and a transmitter eigenbeamforming vector \vec{vⱼ}(f), at a frequency f−1. That is the cross correlation is |\vec{v′ᵢ}(f)\vec{j}(f−1)|. User device(s) 120 or AP 102 may then determine if |\vec{v′ᵢ}(f)\vec{vⱼ}(f−1)| is greater than an absolute value of the autocorrelation of the transmitter eigenbeamforming vector \vec{vᵢ}(f), at a frequency f, and a frequency f−1 (that is |\vec{v′ᵢ}(f)\vec{vᵢ}(f−1)|), for i>j, σᵢ(f)>σⱼ(f), and σᵢ(f−1)>σⱼ(f−1). A rank reversal or channel impulse response perturbation may occur when |\vec{v′ᵢ}(f)\vec{vⱼ}(f−1)|>|\vec{v′ᵢ}(f)\vec{vᵢ}(f−1)| and i>j, σᵢ(f)>σⱼ(f), and σᵢ(f−1)>σⱼ(f−1).

Because each transmitter eigenbeamfomring vector analysis comprises N entries, wherein each entry corresponds to a different transmit antenna, the transmitter eigenbeamforming vectors are said to create a N dimensional subspace. For example, AP 102 may be equipped with N=2 antennas, therefore AP 102 may transmit a data frame \vec{x} using two transmitter eigenbeamforming vectors, and \vec{vₐ}(f) and \vec{v_{b}}(f), with two elements each. That is,

$${\vec{v}}_{a} ( f ) = \begin{matrix}{v}_{a 1} ( f ) \\ {v}_{a 2} ( f )\end{matrix} and {\vec{v}}_{b} ( f ) = \begin{matrix}{v}_{b 1} ( f ) \\ {v}_{b 2} ( f )\end{matrix} ,$$

in a two dimensional subspace. Eigenbeamforming vectors and \vec{vₐ}(f) and \vec{v_{b}} may be associated with beamforming gains σₐ and σ_{b}, respectively and in some embodiments σₐ≈σ_{b}. For instance, AP 102 or user device(s) 120 may determine σₐ and σ_{b} by calculating the diagonal elements of \hat{Σ}(f) as follows. AP 102 or user device(s) 120 may determine Ĥ(f), \hat{Σ}(f), \hat{V}(f), and that \hat{Σ}(f)=Û^{H}(f)Ĥ(f)\hat{V}(f) AP 102 or user device(s) 120 may then pre-multiply \hat{Σ}(f) and Û_{H}(f)Ĥ(f)\hat{V}(f) by a vector [cos θ sin θ] and post-multiply multiply \hat{Σ}(f) and Û^{H}(f)Ĥ(f)\hat{V}(f) by a post multiplication vector.

$$[ \begin{matrix}cos θ \\ sin θ\end{matrix} ] .$$

The value of θ may be any value between 0 and 2π. Accordingly, AP 102 or user device(s) 120 may determine that

$$\begin{matrix}[ cos θ & sin θ ]\end{matrix} [ \begin{matrix}{σ}_{a} & 0 \\ 0 & {σ}_{b}\end{matrix} ] [ \begin{matrix}cos θ \\ sin θ\end{matrix} ] = {σ}_{a} {cos}^{2} ( θ ) + {σ}_{b} {sin}^{2} ( θ ) ,$$

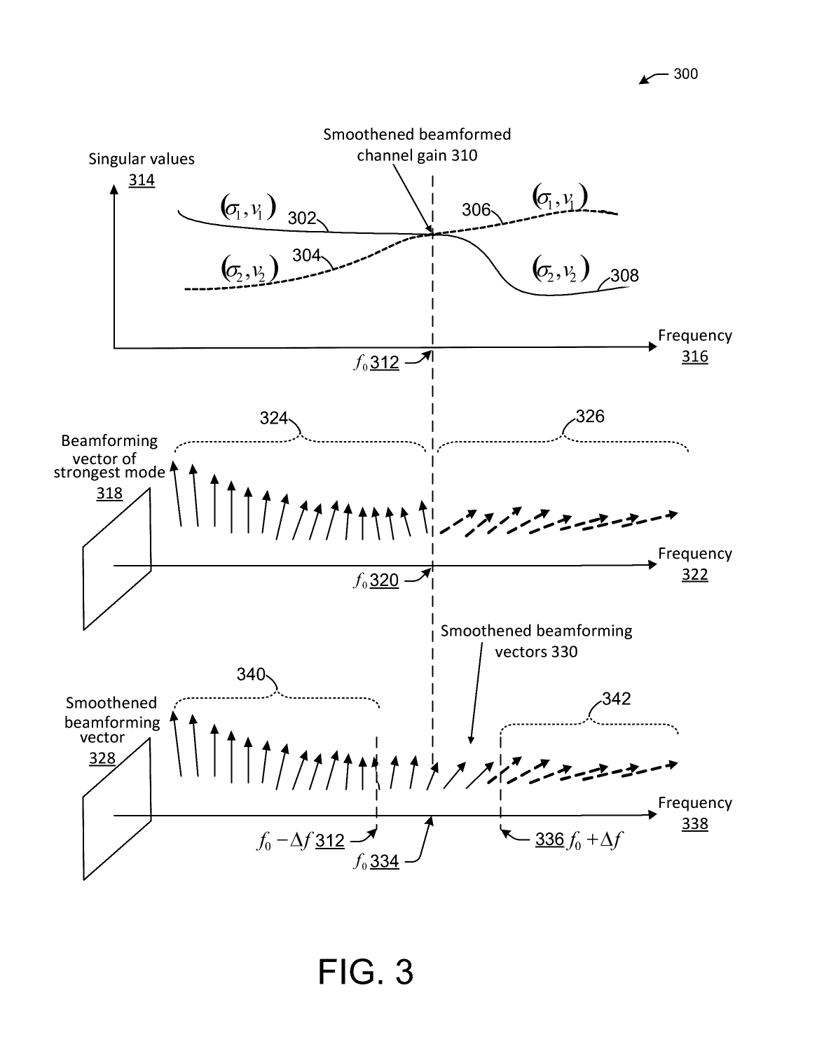

and determine that \vec{vₐ}(f), \vec{v_{b}}(f) \vec{u}_{b}^{H}(f), and \vec{u}_{b}^{H}(f) from Û^{H}(f), may be selected to cause the diagonal elements of Û^{H}(f)Ĥ(f)\hat{V}(f) to be approximately equal thereby resulting in σₐ cos²(θ)+σ_{b} sin²(θ) being approximately equal to σₐ(cos² (θ)+sin² (θ))≈σₐ, because cos²(θ)+sin²(θ)=1. As a result, σₐ will be approximately equal to σ_{b}, and σₐ and σ_{b} will be approximately equal to the diagonal elements of Û^{H}(f)Ĥ(f)\hat{V}(f). In some embodiments, AP 102 or user device(s) 120 may determine the values for σ_{b}, and σₐ by determining eigenvalues for Ĥ(f)Ĥ^{H}(f) and Ĥ^{H}(f)Ĥ(f). In some embodiments, the number of transmitting antennas and receiving antennas may be equal (that is M=N, and the number of eigenvalues and their values will be same for Ĥ(f)Ĥ^{H}(f) and Ĥ^{H}(f)Ĥ(f). If M≠N, then Ĥ(f)Ĥ^{H}(f) may have more eigenvalue associated with it than Ĥ^{H}(f)Ĥ(f) or vice versa. For example, if AP 102 has N>M antennas, where M equals the number of antennas associated with user device 128, then Ĥ^{H}(f)Ĥ(f) may be computed to determine more eigenvalues than Ĥ(f)Ĥ^{H}(f), but the eigenvalues of Ĥ(f)Ĥ^{H}(f) are equal to the eigenvalues of Ĥ^{H}(f)Ĥ(f) excluding the additional eigenvalues associated with Ĥ^{H}(f)Ĥ(f). For instance, there may be N=M+K eigenvalues associated with Ĥ(f)Ĥ(f) and M eigenvalues associated with Ĥ(f)Ĥ^{H}(f), and the M eigenvalues associated with Ĥ(f)Ĥ^{H}(f) and the same as the M eigenvalues associated with Ĥ^{H}(f)Ĥ(f). The values σₐ and σ_{b} may be equal to the square root of the eigenvalues of Ĥ^{H}(f)Ĥ(f) or Ĥ(f)Ĥ^{H}(f) since the M eigenvalues for Ĥ^{H}(f)Ĥ(f) and Ĥ(f)Ĥ^{H}(f) are the same. Thus the gains σₐ(f) and σ_{b}(f), may be approximately the same around the rank reversal frequency or the channel impulse response perturbation frequency. The subspace of the transmitter eigenbeamforming vectors (for example \vec{vₐ}(f) and \vec{_{b}}(f) in a two dimensional subspace) are approximately the same around the rank reversal or channel impulse response perturbation frequency. By same, what is meant is that the orientation and magnitude of the vectors to the left and right of the rank reversal or channel impulse response perturbation frequency are approximately equal to one another, as explained below and illustrated in FIG. 3-5. Because the transmitter eigenbeamforming vectors are approximately the same to the left and right of the rank reversal or channel impulse response perturbation frequency this illustrates that the propagation channel H(f) is continuous. Because there may be frequencies over which transmitter eigenbeamforming vectors \vec{vₐ}(f) and \vec{v_{b}}(f) are not generated, that coincide with the rank reversal or channel impulse response perturbation frequency, and because the transmitter eigenbeamforming vectors, are orthonormal vectors (normalized and orthogonal to each other), the transmitter and/or receiver may generate a set of additional transmitter eigenbeamforming vectors, that are orthonormal and that may be based at least in part on the transmitter eigenbeamforming vectors, that may be used to beamform data frames over the frequencies which transmitter eigenbeamforming vectors are not generated. Thus, the set of additional transmitter eigenbeamforming vectors may be constructed to beamform data frames when a data frame is transmitted using a frequency around the rank reversal or channel impulse response perturbation.

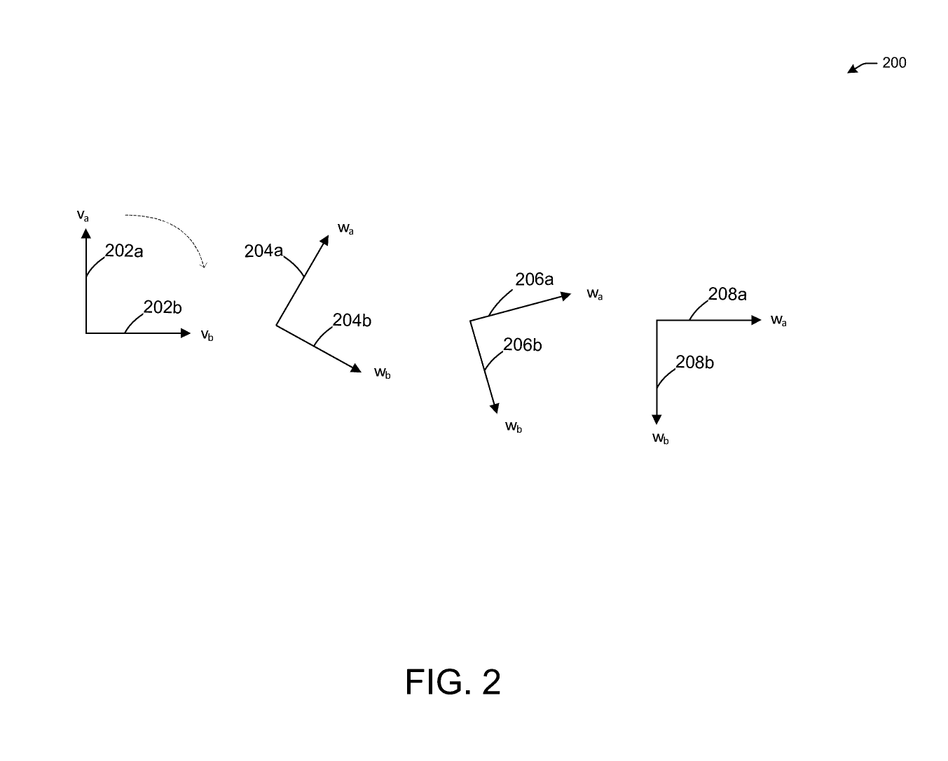

In some embodiments, the set of additional eigenbeamforming vectors may be continuous and may be generated by applying a rotation matrix to the transmitter eigenbeamforming vectors as explained below in reference to FIG. 2.

In one embodiment, and with reference to FIG. 1, a communication channel 142, including beamforming vectors 144, may be established between the AP 102 and the user devices 120. AP 102 and/or user device(s) 120 may determine an estimate of communication channel 142 and may determine at least two beamforming vectors from the estimate of communication channel 142. AP 102 and/or user device(s) 120 may determine that there may be a disruption in communication channel 142, and may determine that there is a discontinuity among beamforming vectors 144, because beamforming vectors 144 are based on communication channel 142 and any disruption to communication channel 142 may cause beamforming vectors 144 to be discontinuous. In some embodiments, a transceiver may determine that a rank reversal has occurred between one or more of beamforming vectors 144, which may also cause a discontinuity among beamforming vectors 144. Accordingly, AP 102 and/or user device(s) 120 may determine one or more additional beamforming vectors based on beamforming vectors 144 and may add the one or more additional beamforming vectors to beamforming vectors 144 to eliminate the discontinuities.

FIG. 2 depicts an illustrative schematic diagram 200 of beamforming vector smoothing, in accordance with one or more example embodiments of the present disclosure. FIG. 2 depicts an illustrative schematic diagram of a rotation of transmitter eigenbeamforming vectors in the transition zone. The transition can be viewed as a series of gradual rotations of orthonormal vectors \vec{vₐ}(f) and \vec{v_{b}}(f) from first orthogonal coordinates \vec{vₐ}(f) and \vec{v_{b}}(f) to second orthogonal coordinates \vec{wₐ}(f) and \vec{w_{b}}(f).

In some embodiments, a beamforming channel smoothing system may synthesize smooth beamforming vectors using the continuous beamforming vectors of the two eigen-modes at the tones, where rank reversal occurs.

The SVD of a MIMO channel H for a tone f can be written as

H(f)=U(f)Σ(f)V′(f),

where V(f)=[v₁(f) . . . vₖ(f)] is the optimal beamforming matrix with the orthonormal, beamforming vectors v₁(f), . . . , vₖ(f); Σ(f)=diag(σ₁(f) . . . σₖ(f)) is the diagonal matrix with the singular values from large to small; M′ denotes the conjugate and transpose of matrix or vector M. An example of rank reversal is as follows. For tone f, v₁(f) may be the beamforming vector with the greatest beamforming gain σ₁(f). For tone f+1, v₁(f+1) may be the beamforming vector with the greatest beamforming gain σ₁(f+1) and v₁(f+1) may look more like beamforming vector v₂(f) than beamforming vector v₁(f). Namely, the second strongest (or another) eigen-mode at tone f becomes the strongest at tone f+1. Note that the rank reversal can happen between any two eigen-modes. It should be understood that the singular values, such as, beamforming gains of the two eigen-modes with rank reversal, may be approximately equal to one another (e.g., σ₁(f) may be approximately equal to σ₂(f). Namely, no matter which of the two modes (or their linear combination) is used for the beamforming the gain is similar. This information may be utilized by a beamforming channel smoothing system for synthesizing smooth beamformed channels as follows.

First, the rank reversal of two eigen-modes may be identified. There are many ways to check whether each beamforming vector vᵢ is replaced by another vector vᵢ with a smaller beamforming gain on the previous tone. For example, one way may be represented by the equation ρ(f)=|v′ᵢ(f)vᵢ(f+1)|. If ρ(f) drops below some threshold (e.g. 0.6), the rank reversal happens. This method can also be used to detect the disruption due to reasons other than rank reversal (for example high frequency selectivity of the beamforming vector). As another example, it may be determined whether |v′ᵢ(f)vⱼ(f−1)|>|v′ᵢ(f)vᵢ(f−1)|, for i<j, σᵢ(f)>σⱼ(f) and σᵢ(f−1)>σⱼ(f−1) . If so, the rank reversal happens. The beamforming vectors and singular values of the two modes switching by vₐ(f), v_{b}(f),σₐ(f), and σ_{b}(f), where a<b and σₐ(f)≠σ_{b}(f) may be denoted. It should be understood that vₐ(f) and v_{b}(f) form a 2D subspace inside which the beamforming vectors all have very similar beamforming gain. Namely,

$${[ \begin{matrix}cos ( θ ) \\ sin ( θ )\end{matrix} ]}^{′} \begin{matrix}[ {u}_{a} ( f ) & {u}_{b} ( f ) ]\end{matrix} H ( f ) \begin{matrix}[ {v}_{a} ( f ) & {v}_{b} ( f ) ]\end{matrix} [ \begin{matrix}cos ( θ ) \\ sin ( θ )\end{matrix} ] \approx {σ}_{b} ( f ) \approx {σ}_{a} ( f ) ,$$

for θ ∈[0, 2 π].

In addition, the 2D subspace may remain about the same for the tones around the rank reversal tone, for example, [vₐ(f) v_{b}(f)] remaining unchanged for f around the reversal point because the underlying propagation channel is continuous. In the case where the disruption is caused by high frequency selectivity, the 2D subspace also remains about the same and the beamforming vectors inside the subspace also has similar beamforming gains. Furthermore, it is noted that vₐ(f) and _{b} (f) are orthogonal with each other. A set of beamforming vector pairs [wₐ(f) w_{b}(f)] may be constructed from [vₐ(f) v_{b}(f)] for f around the reversal point f₀ such that the beamforming vector pairs [wₐ(f) w_{b}(f)] are continuous by

$$[ \begin{matrix}{w}_{a} ( f ) & {w}_{b} ( f )\end{matrix} ] = [ \begin{matrix}{v}_{a} ( f ) & {v}_{b} ( f )\end{matrix} ] [ \begin{matrix}cos ( {θ}_{f} ) & sin ( {θ}_{f} ) \\ - sin ( {θ}_{f} ) & cos ( {θ}_{f} )\end{matrix} ] ,$$

where θ_{f} ∈[0, π/2] is a continuous function of f .

For example, beamforming vectors vₐ(f) 202a and v_{b}(f) 202b may be rotated by rotation matrix

$$[ \begin{matrix}cos ( {θ}_{f} ) & sin ( {θ}_{f} ) \\ - sin ( {θ}_{f} ) & cos ( {θ}_{f} )\end{matrix} ]$$

throughout a two dimensional subspace so that beamforming vector Vₐ(f) 202a is rotated θ_{f} degrees into the position of beamforming vector wₐ(f) 204a and beamforming vector v_{b}(f) 202b is rotated θ_{f} degrees into the position of beamforming vector w_{b}(f) 204b, wherein θ_{f} may be a first value. The rotation matrix may be applied to beamforming vectors Vₐ (f) 202a and v_{b}(f) 202b wherein θ_{f} may be a second value thereby causing Vₐ(f) 202a and v_{b}(f) 202b to be rotated into the position of beamforming vectors wₐ(f) 206a and w_{b}(f) 206b, and the rotation matrix may be applied again, wherein θ_{f} is equal to a third value, to cause vₐ(f) 202a and v_{hd b} (f) 202b to be rotated in the position of beamforming vectors wₐ(f) 208a and w_{b}(f) 208b. There are many functions for θ_{f}. For example,

$${θ}_{f} = \frac{π}{4 Δ f} ( f - {f}_{0} ) + \frac{π}{4} ,$$

for f ∈[f₀−Δf, f₀+Δf], where 2Δf is the transition interval size. The transition interval including f₀ in the center and few other tones e.g. 2-5 tones on the left and right, respectively. The transition can be viewed as a series of gradual rotations of the orthogonal coordinate [vₐ(f) v_{b}(f)] as shown in FIG. 2. For example, wₐ(f) points to vₐ(f) initially and points to v_{b}(f) at the end. Namely, Vₐ(f) and v_{b}(f) switch their positions. At the rank reversal point f₀, half of the beamforming vector is contributed by vₐ(f) and the other half is from v_{b}(f). If only one of wₐ(f) and w_{b}(f) needs to be fed back or used, the device may only need to compute one not both. The device that measures the full MIMO channel has all the information about the eigen-modes and rank reversal. For example, the receiver device using explicit feedback and the transmitter device using implicit feedback have such information. In a specification, it may be mandated to perform the smooth transition for the other side of the link.

θ_{f} may initially be equal to 0, for vₐ(f) 202a and v_{b}(f) 202b, and may be equal to

$$\frac{π}{2}$$

for wₐ(f) 208 a and w_{b}(f) 208b. That is, initial orthogonal coordinates vₐ(f) 202a and v_{b}(f) 202b may be multiplied by the rotation matrix, where θ_{f}=0 resulting in wₐ(f)=vₐ(f) and w_{b}(f)=v_{b}(f). So the orientation of wₐ(f) and w_{b}(f) is equal to the initial orientation of initial orthogonal coordinates vₐ(f) 202a and v_{b} (f) 202b. Orthogonal coordinates wₐ(f) 204a and w_{b}(f) 204b may be rotations of vₐ(f) 202a and v_{b}(f) 202b by

$${θ}_{f} \approx 25 \cdot \frac{π}{180} = \frac{5 π}{36}$$

radians. Orthogonal coordinates wₐ(f) 206 a and w_{b} (f) 206 b may be rotations of vₐ(f) 202a and v_{b}(f) 202b by

$${θ}_{f} \approx 80 \cdot \frac{π}{180} = \frac{4 π}{9}$$

radians. Orthogonal coordinates wₐ(f) 208 a and w_{b}(f) 208 b may be rotations of vₐ(f) 202a and v_{b}(f) 202b by

$${θ}_{f} \approx \frac{π}{2}$$

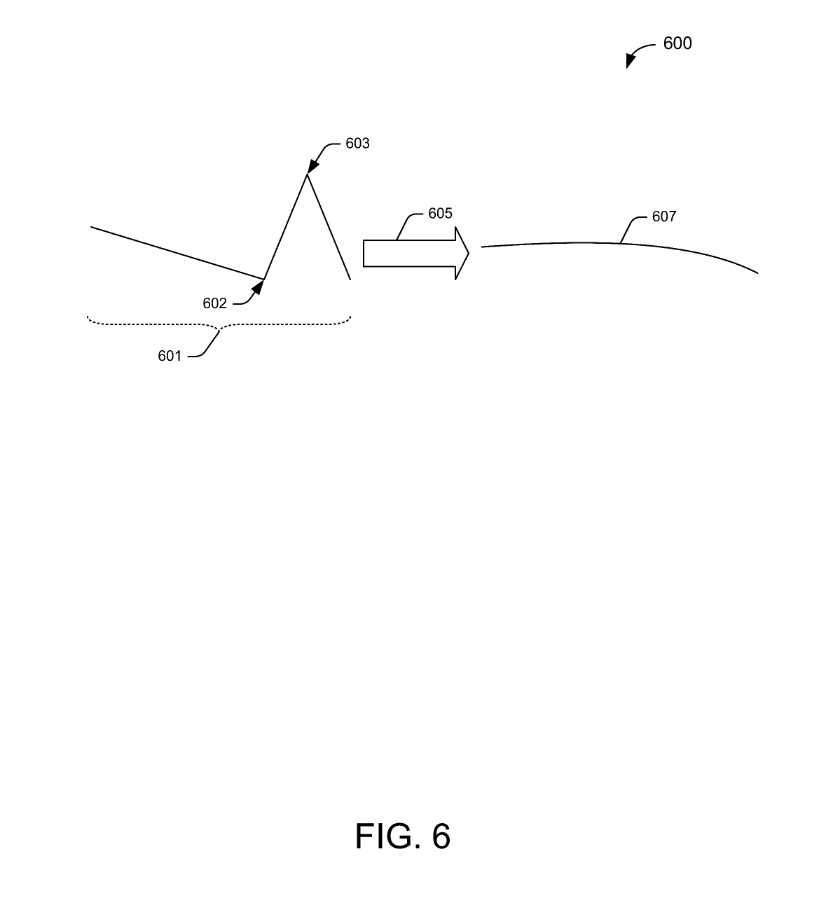

ramans. because θ_{f} is a continuous function the Cardinality of the set of additional transmitter eigenbeamforming vectors may be predetermined. For example, a transition zone [f₀−Δf, f₀+Δf] may be divided into as little a set of 1 additional transmitter eigenebeamforming vector, or a set of as many as 10,000 or more additional transmitter eigenbeamforming vectors. This may correspond to 10,000 or more linear combinations of vₐ(f) 202a and v_{b}(f) 202b. The Cardinality of the set of additional transmitter eigenbeamforming vectors may be based at least in part on a discontinuity of the beamforming gain as illustrated in FIG. 6.

FIG. 3 depicts an illustrative schematic diagram of beamforming vector smoothing, in accordance with one or more example embodiments of the present disclosure. Comparative diagram 300 illustrates a relationship between singular values and beamforming vectors that may be determined by a receiver device, and/or a transmitter device. Singular values 314 may be a first axis along which singular values, for a corresponding strongest beamforming vector, may be plotted as a function of a set of frequencies on a second axis (, Frequency 316). For instance, singular values (σ₁(f), v₁(f)) 302, may be the singular values (e.g., beamforming gain) corresponding to beamforming vectors v₁(f) 324, and singular values (σ₂(f), v₂(f)) 304 may correspond to a beamforming vector v₂(f) (not shown). At tone f₀ 312, a new singular value (smoothened beamformed channel gain 302) may be added to singular values 314. Smoothened beamformed channel gain 302 may correspond to a set of smoothened beamforming vectors 330 and may be determined as explained below. Singular values (σ₁(f), v₁(f)) 306 may be the singular values (e.g., beamforming gain) corresponding to beamforming vectors v₂(f) 326, and singular values (σ₂(f), v₂(f)) 308 may correspond to a beamforming vector v₁(f) (not shown).

Beamforming vector of strongest mode 318 may be a first axis along which the strongest beamforming vector vᵢ(f) of a set of beamforming vectors v₁(f), . . . , vₖ(f), may be plotted as a function of a set of frequencies on a second axis (Frequencies 322). For instance the set of beamforming vectors v₁(f), . . . , vₖ(f) may comprise k=2 beamforming vectors wherein the first beamforming vector corresponds to beamforming vectors v₁(f) 324 and the second beamforming vector corresponds to beamforming vectors v₂(f) 326. At tone f₀ 320 there may be a gap between beamforming vectors v₁(f) 324 and beamforming vectors v₂(f) 326 wherein the receiver device and/or transmitter device do not generate beamforming vectors. This gap may be filled with synthesized beamforming vectors as illustrated in smoothened beamforming vector 328.

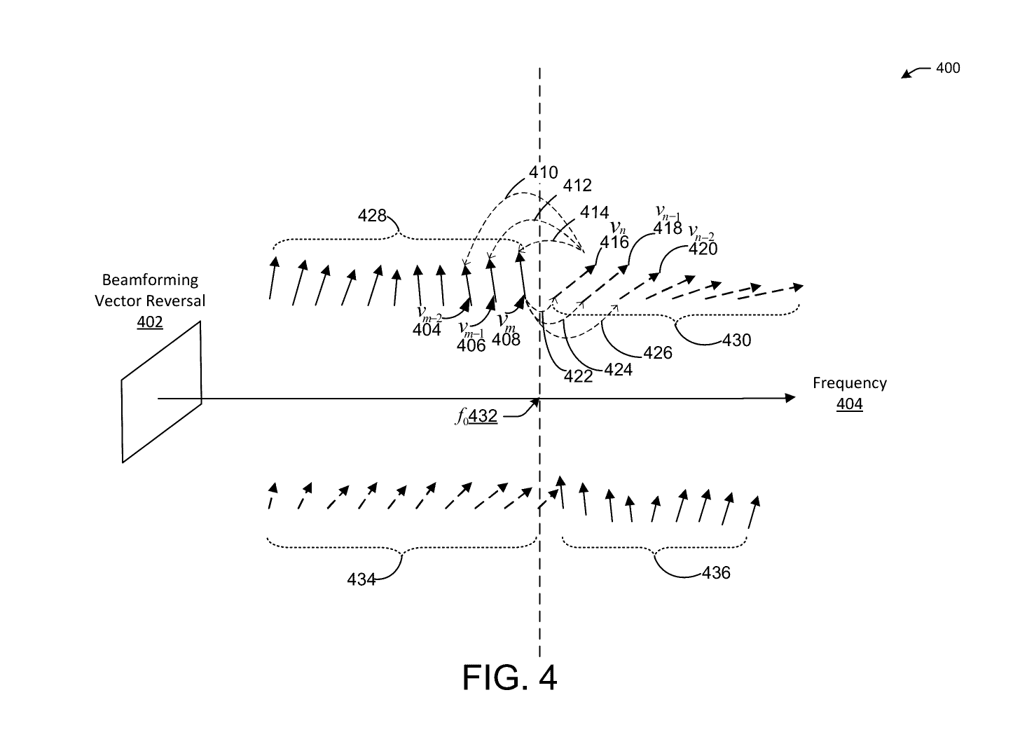

Smoothened beamforming vector 328 may be a first axis along which the strongest beamforming vector vᵢ(f) of a set of beamforming vectors v₁(f), . . . , vₖ(f), and a set of smoothened beamforming vectors may be plotted as a function of a set of frequencies on a second axis (, Frequencies 338 ). For instance the set of beamforming vectors v₁(f), . . . , vₖ(f) may comprise k=2 beamforming vectors wherein the first beamforming vector corresponds to beamforming vectors v₁(f) 340 and the second beamforming vector corresponds to beamforming vectors v₂(f) 342. At tone f₀ 334, which corresponds to tone f₀ 320 where the gap in beamforming vectors exists, by be filled with at least one beamforming vector. In particular there may be a range of frequencies (e.g., tone f₀ Δf 332 to tone f₀+Δf) 336) centered around tone f₀ 334 over which smoothened beamforming vectors 330 may be added as explained below in reference to FIG. 4.

In some embodiments there may be a metric to define smoothness. In one embodiment smoothness may be determined by the magnitude of the first derivative and the second derivative of ρ(f). For example, an upper limit may be put in place for |Δρ(f)| such that the smoothing scheme does not output a significant jump in the transition zone. In some embodiments an upper limit may be established for a variation rate of Δρ(f) as explained below in reference to FIG. 6.

FIG. 4 depicts an illustrative schematic diagram 400 of beamforming channel smoothing, in accordance with one or more example embodiments of the present disclosure. In some embodiments, the transmitter device may need to do the smoothing without knowing both beamforming vectors, whose positions are reversed in the rank reversal. Beamforming vector reversal 402 may be a first axis along which the strongest beamforming vector vᵢ(f) of a set of beamforming vectors v₁(f), . . . , vₖ(f), may be plotted as a function of a set of frequencies on a second axis (, Frequencies 404). For instance the set of beamforming vectors v₁(f), . . . , vₖ(f) may comprise K=2 beamforming vectors wherein the first beamforming vector corresponds to beamforming vectors v₁(f) 428 and the second beamforming vector corresponds to beamforming vectors v₂(f) 430. For example, a device (e.g., the AP 120) may only know the beamforming vectors (e.g., beamforming vectors 428 and 430) for the stronger eigen-mode as shown in the upper portion of FIG. 4. Thus, the lower portion with the beamforming vectors (e.g., beamforming vectors 434 and 436) for the weaker eigen-mode may be unavailable to the device. The disruption due to rank reversal or high frequency selectivity may be detected between vectors vₘ 408 and vₙ 416. Vector vₘ 408 can be used for channel smoothing with vectors vₙ 416, vₙ₋₁ 418, and vₙ₋₂ 420. For example, vₙ 416, vₙ₋₁ 418, vₙ₋₂ 420 are in the place of vₐ(f) in the above described equation:

$$[ \begin{matrix}{w}_{a} ( f ) & {w}_{b} ( f )\end{matrix} ] = [ \begin{matrix}{v}_{a} ( f ) & {v}_{b} ( f )\end{matrix} ] [ \begin{matrix}cos ( {θ}_{f} ) & sin ( {θ}_{f} ) \\ - sin ( {θ}_{f} ) & cos ( {θ}_{f} )\end{matrix} ] ,$$

and vₘ 408 is in the place of v_{b}(f) in the aforementioned equation.

The synthesized vectors with power normalization (and maybe orthogonalization) are used to replace vₙ 416, vₙ₋₁ 418, and vₙ₋₂ 420. Similarly, the vector vₙ 416 can be used for channel smoothing with vectors vₘ 408, vₘ₋₁ 406, vₘ₋₂ 404. The synthesized vectors with power normalization (and maybe orthogonalization) may be used to replace vₘ 408, vₘ₋₁ 406, vₘ₋₂ 404. Because of the approximation, the beamforming gain may drop a little bit. It should be noticed that the methods depicted with FIG. 3 and FIG. 4 can be used to smoothen disruptions due to reasons other than rank reversal (for example due to high frequency selectivity). As an example, any disruption in the beamforming vector across the frequency can be mitigated using the methods around the disruption point as long as the original beamforming vectors before and after the disruption point are smooth, respectively.

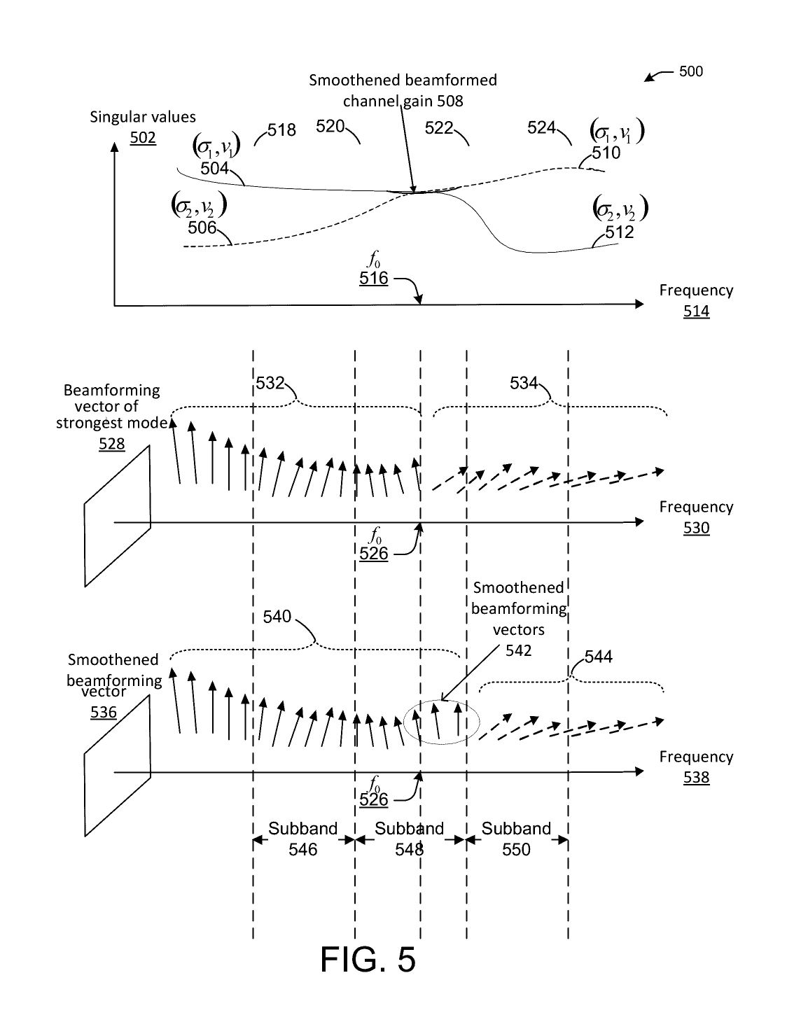

FIG. 5 depicts an illustrative schematic diagram 500 of piecewise continuous beamforming, in accordance with one or more example embodiments of the present disclosure. Singular values 502 may be a first axis along which singular values, for a corresponding strongest beamforming vector, may be plotted as a function of a set of frequencies on a second axis (, Frequency 514). For instance, singular values (σ₁(f), v₁(f)) 504, may be the singular values (e.g., beamforming gain) corresponding to beamforming vectors v₁(f) 532, and singular values (σ₂(f), v₂(f)) 506 may correspond to a beamforming vector v₂(f) (not shown). At tone f₀ 516, a new singular value (smoothened beamformed channel gain 508) may be added to singular values 502. Smoothened beamformed channel gain 508 may correspond to a set of smoothened beamforming vectors 542 and may be determined as explained above with reference to FIG. 4. Singular values (σ₁(f), v₁(f)) 510 may be the singular values (e.g., beamforming gain) corresponding to beamforming vectors v₂(f) 534, and singular values (σ₂(f), v₂(f)) 512 may correspond to a beamforming vector v₁(f) (not shown).

Beamforming vector of strongest mode 528 may be a first axis along which the strongest beamforming vector vᵢ(f) of a set of beamforming vectors v₁(f), . . . , vₖ(f), may be plotted as a function of a set of frequencies on a second axis (, Frequencies 530). For instance the set of beamforming vectors v₁(f), . . . , vₖ(f) may comprise K=2 beamforming vectors wherein the first beamforming vector corresponds to beamforming vectors v₁(f) 532 and the second beamforming vector corresponds to beamforming vectors v₂(f) 534. At tone f₀ 526 there may be a gap between beamforming vectors v₁(f) 532 and beamforming vectors v₂(f) 534 wherein the receiver device and/or transmitter device do not generate beamforming vectors. This gap may be filled with synthesized beamforming vectors as illustrated in smoothened beamforming vector 536.

Smoothened beamforming vector 536 may be a first axis along which the strongest beamforming vector vᵢ(f) of a set of beamforming vectors v₁(f), . . . , vₖ(f), and a set of smoothened beamforming vectors may be plotted as a function of a set of frequencies on a second axis (, Frequencies 538). For instance the set of beamforming vectors v₁(f), . . . , vₖ(f) may comprise K=2 beamforming vectors wherein the first beamforming vector corresponds to beamforming vectors v₁(f) 540 and the second beamforming vector corresponds to beamforming vectors v₂(f) 544. At tone f₀ 552, which corresponds to tone f₀ 526 where the gap in beamforming vectors exists, by be filled with at least one beamforming vector. In particular, there may be a range of frequencies corresponding to a subband (e.g., Subband 548) centered around a tone (e.g., tone f₀ 552) over which smoothened beamforming vectors 542 may be added as explained above in reference to FIG. 4. Subbands 546 and 550 may comprise beamforming vectors corresponding to beamforming vectors 540 and 544 respectively wherein no gaps exist, because the strongest beamforming vector is used continuously throughout the corresponding subbands. If computation complexity is a concern at the mobile station for smoothing the beamforming vectors, the following simplified scheme may be utilized. Beamforming vectors with disruptions may be fed back to the transmitter device and let the transmitter device take the burden of smoothing. The transmitter device may need to do the smoothing without knowing both beamforming vectors, whose positions are reversed in the rank reversal. As shown in FIG. 5, a channel bandwidth may be divided into subbands. Within each subband, the beamforming vector is continuous. Namely, the device (e.g., the AP 102) may either smooth the beamforming vectors (as described in FIGS. 3 and 4) or may just simply not switch to the stronger beamforming vector after (or before) the rank reversal occurs within each subband. Across subbands, the beamforming vector can make a disruptive change. The disruptive change allows a receiver device to perform channel smoothing on the channel estimates within each subband. The smaller the subband size, the smaller the beamforming gain loss and the smaller the gain from channel estimate smoothing. The subband size may be about 2 MHz. Namely, for a 26 tone resource unit (RU), the beamforming vectors may be continuous. The smallest RU for 802.11ax. Because there are leftover tones in the band, the subband size may be slightly greater than 26 tones by 1-4 tones.

For improved addressing of the leftover tones, a single subband size may not be used. Instead, each bandwidth unit used by the beamforming feedback or beamforming transmission may be divided into subbands, which may have multiple sizes (e.g. 1-3 sizes). The boundaries of the subbands may be previously specified according to a specification. Any large change of the beamforming vector may only happens across the boundaries. For example, a large 106-tone RU, may be divided into four subbands with 26 tones and 27 tones, respectively. It should be noticed that the methods depicted with FIG. 3 and FIG. 4 can be used to smoothen disruptions due to reasons other than rank reversal (for example due to high frequency selectivity). As an example, any disruption in the beamforming vector across the frequency can be mitigated using the methods around the disruption point as long as the original beamforming vectors before and after the disruption point are smooth, respectively.

In some embodiments, disruption may be due to quantization. For example, the quantization of a beamforming vector (a V vector) may also cause disruptions. For example, the quantization may be up to a global phase (, \hat{V}(f)=e^{ja}V(f)), where α is the global phase for the vector. The effect of the global phase can be removed by subtracting the phase from the quantized vector. For example, \hat{V}(f)=\hat{V}(f)exp (j·phase (diag (\hat{V}(f)\hat{V}(f−1)))), where \hat{V}(f) and \hat{V}(f−1) are beamforming matrixes. Namely, each beamforming vector of the current tone may be projected to the corresponding ones of the previous tone and the phases of the projections may be computed. The phases may then be removed from the current tone so that the continuity of the beamforming vectors across tones is maximized. Besides the global phase, the quantization can cause the disruption due to quantization errors. These small jumps may be removed by smoothing or filtering at the transmitter device.

FIG. 6 depicts an illustrative schematic diagram of a continuous beamforming curve across tones, in accordance with one or more example embodiments of the present disclosure. As mentioned above, an upper limit may be established for a variation rate of Δρ(f) based at least in part on beamforming weights. Beamforming weights 601 may represent an exemplary continuous set of beamforming weights that maybe quantized to produce discrete beamforming vectors (not shown). Beamforming weights 601 may comprise maximum point 603 which may correspond to a maximum weight and minimum point 602 may correspond to a minimum weight both of which are associated with different tones. The second derivative of beamforming weights 601 at maximum point 603 and minimum point 602 may generate discontinuous values for beamforming weights at maximum point 603 and minimum point 602. Accordingly, a smoothing function (e.g., smooth function 605) may be applied to beamforming weights 601 to produce a smooth curve representing a smooth set of beamforming weights that may be used to produce a set of beamforming vectors whose second derivative values are not discontinuous. The quantized beamforming vector may be bumpy due to quantization steps or errors. The transmitter receives the quantized beamforming vectors. Before using them, the transmitter applies smoothing to generate smooth beamforming vectors for the actual beamforming.

The smoothing of the beamforming vectors at the transmitter device may enable the smoothing of the channel estimates at the receiver device. The smoothing at the receiver device side may provide gains via better channel estimation. Low cost devices may not be able to support smoothing of beamforming vectors; therefore a transmitting device may need to indicate in a physical (PHY) header whether channel smoothing should be applied at the receiver device. A bit may be used in the PHY header to indicate whether the channel is beamformed. Additionally and/or alternatively the bit may also be used to indicate whether channel smoothing should be done by the receiver device. The bit may be called a smoothing bit. Piecewise contiguous beamforming or full band continuous beamforming may be applied to one or more legacy portions of a frame (e.g., Legacy Long Training Field (L-LTF) and/or Legacy Signal (L-SIG) fields) and/or High Efficiency SIGNAL Field A (HE-SIG-A). Thus if the smoothing bit is set to a value (e.g., 0 or 1) indicating that continuous beamforming weights have been applied to the legacy portions and a first High Efficiency Long Training Field (HE-LTF) symbol or High Efficiency (HE) stream, the receiver device may apply channel smoothing. The smoothing bit may indicate that the beamforming weights applied to the legacy portion and the first HE-LTF symbol or HE stream are the same.

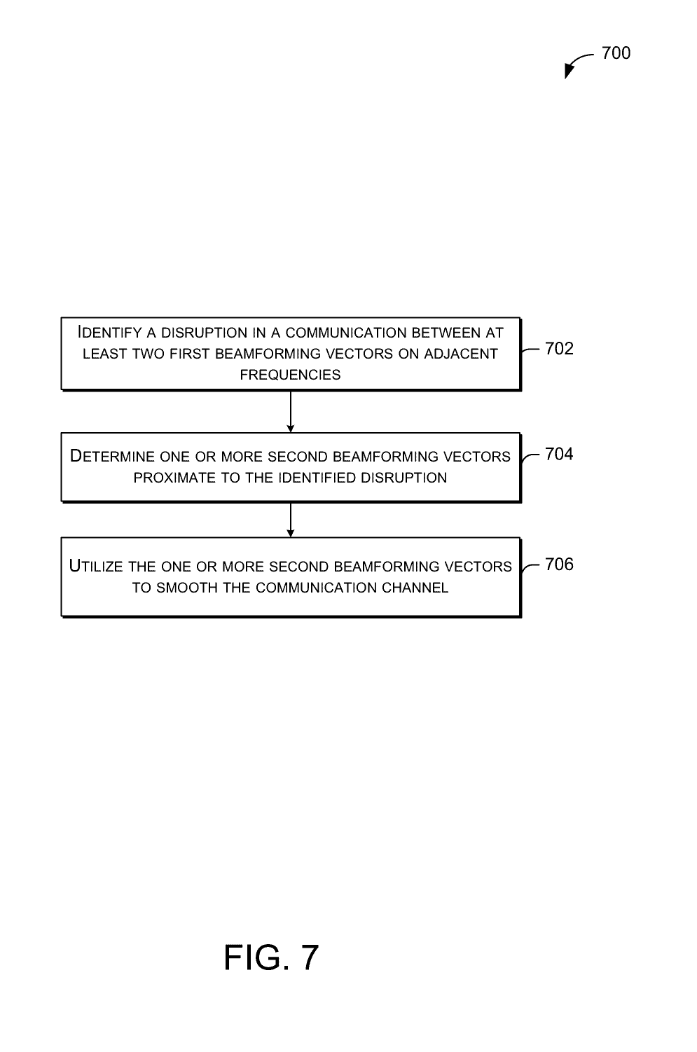

FIG. 7 illustrates a flow diagram of illustrative process 700 for applying beamforming vector smoothing to beamformed channels in accordance with one or more embodiments of the disclosure.

At block 702, a device (e.g., user device 120 or AP 102 of FIG. 1) may identify a disruption in a communication channel between at least two first beamforming vectors on adjacent frequencies. In some embodiments, a rank reversal between at least two eigen-modes in a communication channel may occur instead of a disruption in the communication channel. The device may determine that a disruption in the communication channel or rank reversal may occur by determining ρ(f)=|v′ᵢ(f)vᵢ(f+1)| drops below some threshold (e.g., 0.6). For example, a disruption in the communication channel or a rank reversal may occur when a vector at a first frequency is projected onto itself (, multiplied by itself) at a second frequency (, v′ᵢ(f)vᵢ(f+1)) and the absolute value of the result of the multiplication falls below a predetermined threshold. When the value of ρ(f) drops below a certain threshold, the vector is decreasing in correlation with itself after a certain frequency. For instance, beamforming vector v′ᵢ(f) at frequency f may be less correlated with itself at another frequency f+1 (e.g., v′ᵢ(f+1)) due to perturbation in the communication channel, and may cause the disruption in the communication channel or the rank reversal to occur.

At block 704, the device may determine one or more beamforming vectors based on the identified disruption in the communication channel or the rank reversal. The one or more beamforming vectors may be determined based at least in part on the eigenvectors of the matrix multiplication of the communication channel denoted by H and the Hermitian (transpose and complex conjugate) of the communication channel denoted by H*. In particular, the beamforming vectors (e.g., v₁(f), . . . , vₖ(f)), may be equal to the eigenvectors (e.g., of the matrix multiplication HH*).

At block 706, the device may utilize the one or more beamforming vectors for smoothing the communication channel. For instance, a beamforming vector (e.g., vector vₘ 408) and one or more other beamforming vectors (e.g., vₙ 416, vₙ₋₁ 418, and vₙ₋₂ 420) can be used for channel smoothing. For example, vₙ 416, vₙ₋₁ 418, vₙ₋₂ 420 may be rotated by (e.g., multiplied by) a rotation matrix

$$[ \begin{matrix}cos ( {θ}_{f} ) & sin ( {θ}_{f} ) \\ - sin ( {θ}_{f} ) & cos ( {θ}_{f} )\end{matrix} ]$$

to generate a first rotated beamforming vector over a first range of frequencies and vₘ 408 may also be rotated by the rotation matrix to generate a second rotated beamforming vector over a second range of frequencies. The rotated beamforming vectors may be synthesized with power normalization (and maybe orthogonalization) and may be used to replace vₙ 416, vₙ₋₁ 418, and vₙ₋₂ 420. Similarly, beamforming vector vₙ 416 can be used for channel smoothing with beamforming vectors vₘ 408, vₘ₋₁ 406, vₘ₋₂ 404, wherein beamforming vector vₙ 416, and beamforming vectors vₘ 408, vₘ₋₁ 406, vₘ₋₂ 404 may be rotated by the rotation matrix. The rotated beamforming vectors may be synthesized with power normalization (and maybe orthogonalization) may be used to replace vₘ 408, vₘ₋₁ 406, vₘ₋₂ 404. The method may end after block 706.

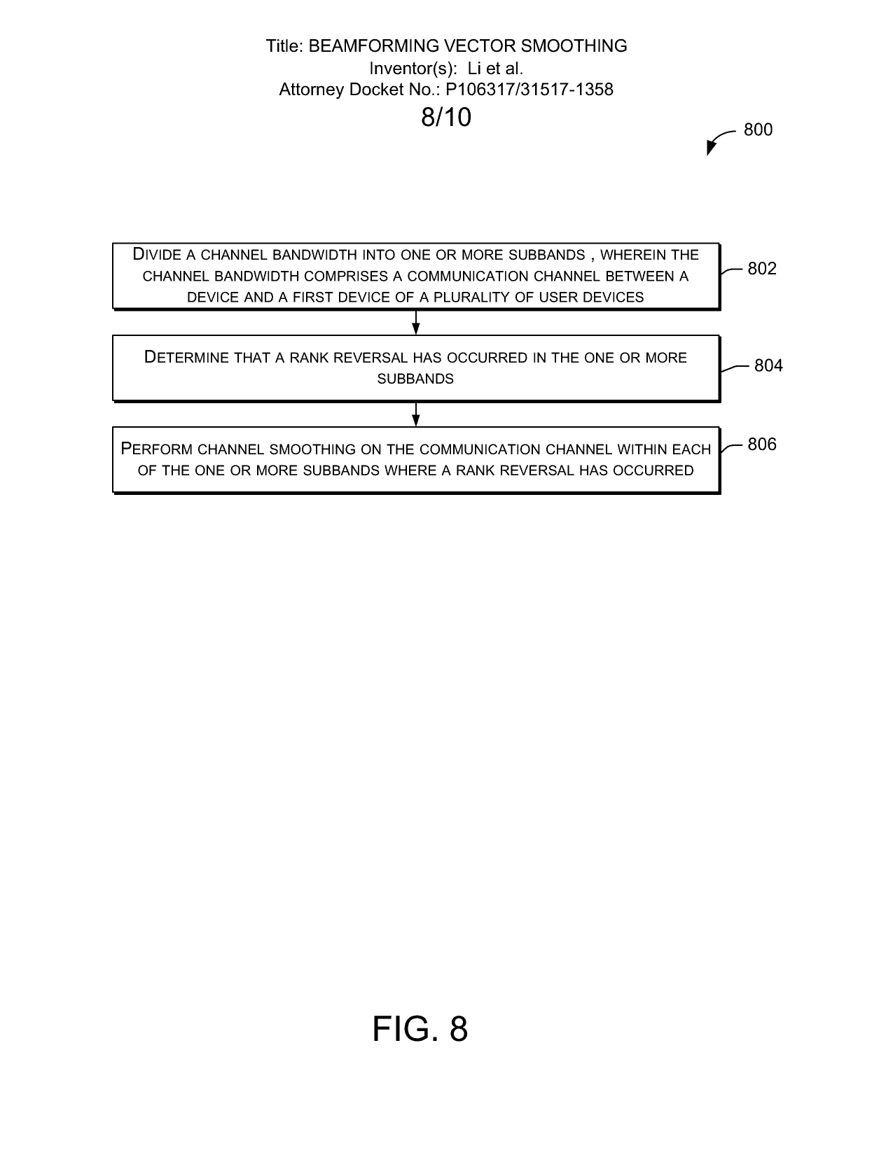

FIG. 8 illustrates a flow diagram of illustrative process 800 for applying channel smoothing to beamformed channels in accordance with one or more embodiments of the disclosure.

At block 802, a device (e.g., user device 120 or AP 102) may divide a channel bandwidth into one or more subbands, wherein the channel bandwidth comprises a communication channel between a device and a first device of a plurality of user devices. The device may divide the channel bandwidth into one or more subbands based on a predetermined number, and/or historical data about a communication channel associated with the channel bandwidth, wherein the historical data comprises information about frequencies over which the communication channel may cause the device to perform a rank reversal.

After block 802, the device may determine that a rank reversal or a disruption in the communication channel has occurred in the one or more subbands at block 804.

At block 806, the device may perform channel smoothing on the communication channel within each of the one or more subbands where a rank reversal or the disruption in the communication channel has occurred. The device may perform channel smoothing on the communication channel within each of the one or more subbands where a rank reversal or the disruption in the communication channel has occurred by utilizing the one or more beamforming vectors for smoothing the communication channel. For instance, a beamforming vector (e.g., vector vₘ 408) and one or more other beamforming vectors (e.g., vₙ 416, vₙ₋₁ 418, and vₙ₋₂ 420) can be used for channel smoothing. For example, vₙ 416, vₙ₋₁ 418, vₙ₋₂ 420 may be rotated by (e.g., multiplied by) a rotation matrix

$$[ \begin{matrix}cos ( {θ}_{f} ) & sin ( {θ}_{f} ) \\ - sin ( {θ}_{f} ) & cos ( {θ}_{f} )\end{matrix} ]$$

to generate a first rotated beamforming vector over a first range of frequencies and vₘ 408 may also be rotated by the rotation matrix to generate a second rotated beamforming vector over a second range of frequencies. The rotated beamforming vectors may be synthesized with power normalization (and maybe orthogonalization) and may be used to replace vₙ 416, vₙ₋₁ 418, and vₙ₋₂ 420. Similarly, beamforming vector vₙ 416 can be used for channel smoothing with beamforming vectors vₘ 408, vₘ₋₁ 406, vₘ₋₂ 404, wherein beamforming vector vₙ 416, and beamforming vectors vₘ 408, vₘ₋₁ 406, vₘ₋₂ 404 may be rotated by the rotation matrix. The rotated beamforming vectors may be synthesized with power normalization (and maybe orthogonalization) may be used to replace vₘ 408, vₘ₋₁ 406, vₘ₋₂ 2 404. The method may end after block 806.

FIG. 9 shows a functional diagram of an exemplary communication station 900 in accordance with some embodiments. In one embodiment, FIG. 9 illustrates a functional block diagram of a communication station that may be suitable for use as an AP 102 (FIG. 1) or a user device 120 (FIG. 1) in accordance with some embodiments. The communication station 900 may also be suitable for use as a handheld device, mobile device, cellular telephone, smartphone, tablet, netbook, wireless terminal, laptop computer, wearable computer device, femtocell, High Data Rate (HDR) subscriber station, access point, access terminal, or other personal communication system (PCS) device.

The communication station 900 may include communications circuitry 902 and a transceiver 910 for transmitting and receiving signals to and from other communication stations using one or more antennas 901. The communications circuitry 902 may include circuitry that can operate the physical layer communications and/or medium access control (MAC) communications for controlling access to the wireless medium, and/or any other communications layers for transmitting and receiving signals. The communication station 900 may also include processing circuitry 906 and memory 908 arranged to perform the operations described herein. In some embodiments, the communications circuitry 902 and the processing circuitry 906 may be configured to perform operations detailed in FIGS. 2-7.

In accordance with some embodiments, the communications circuitry 902 may be arranged to contend for a wireless medium and configure frames or packets for communicating over the wireless medium. The communications circuitry 902 may be arranged to transmit and receive signals. The communications circuitry 902 may also include circuitry for modulation/demodulation, upconversion/downconversion, filtering, amplification, etc. In some embodiments, the processing circuitry 906 of the communication station 900 may include one or more processors. In other embodiments, two or more antennas 901 may be coupled to the communications circuitry 902 arranged for sending and receiving signals. The memory 908 may store information for configuring the processing circuitry 906 to perform operations for configuring and transmitting message frames and performing the various operations described herein. The memory 908 may include any type of memory, including non-transitory memory, for storing information in a form readable by a machine (e.g., a computer). For example, the memory 908 may include a computer-readable storage device may, read-only memory (ROM), random-access memory (RAM), magnetic disk storage media, optical storage media, flash-memory devices and other storage devices and media.

In some embodiments, the communication station 900 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 900 may include one or more antennas 901. The antennas 901 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 900 may include one or more of a keyboard, a display, a non-volatile memory port, multiple antennas, a graphics processor, an application processor, speakers, and other mobile device elements. The display may be an LCD screen including a touch screen.

Although the communication station 900 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 900 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 900 may include one or more processors and may be configured with instructions stored on a computer-readable storage device memory.

FIG. 10 illustrates a block diagram of an example of a machine 1000 or system upon which any one or more of the techniques (e.g., methodologies) discussed herein may be performed. In other embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environments. The machine 1000 may be a personal computer (PC), a tablet PC, a set-top box (STB), a personal digital assistant (PDA), a mobile telephone, wearable computer device, a web appliance, a network router, switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a power management device 1032, a graphics display device 1010, an alphanumeric input device 1012 (e.g., a keyboard), and a user interface (UI) navigation device 1014 (e.g., a mouse). In an example, the graphics display device 1010, alphanumeric input device 1012, and UI navigation device 1014 may be a touch screen display. The machine 1000 may additionally include a storage device (, drive unit) 1016, a signal generation device 1018 (e.g., a speaker), a beamforming channel smoothing device 1019, a network interface device/transceiver 1020 coupled to antenna(s) 1030, and one or more sensors 1028, such as a global positioning system (GPS) sensor, compass, accelerometer, or other sensor. The machine 1000 may include an output controller 1034, such as a serial (e.g., universal serial bus (USB), parallel, or other wired or wireless (e.g., infrared (IR), near field communication (NFC), etc.) connection to communicate with or control one or more peripheral devices (e.g., a printer, card reader, etc.)).

The storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, or within the hardware processor 1002 during execution thereof by the machine 1000. In an example, one or any combination of the hardware processor 1002, the main memory 1004, the static memory 1006, or the storage device 1016 may constitute machine-readable media.

The beamforming channel smoothing device 1019 may carry out or perform any of the operations and processes (e.g., processes 700 and 800) described and shown above. For example, the beamforming vector smoothing device 1019 may be configured to determine a rank reversal and/or disruptions in the beamforming vector across one or more frequencies by synthesizing smooth beamforming vectors utilizing continuous beamforming vectors of two eigen-modes where rank reversal occurs. Beamforming vector smoothing device 1019 may determine that a channel bandwidth is divided into one or more subbands, and that each of the one or more subbands includes a continuous beamforming vector. Beamforming vector smoothing device 1019 may smooth continuous beamforming vectors on channel estimates within each of the one or more subbands.

It is understood that the above are only a subset of what the beamforming channel smoothing device 1019 may be configured to perform and that other functions included throughout this disclosure may also be performed by the beamforming channel smoothing device 1019.

The instructions 1024 may carry out or perform any of the operations and processes (e.g., processes 700 and 800) described and shown above.

While the machine-readable medium 1022 is illustrated as a single medium, the term “machine-readable medium” may include a single medium or multiple media (e.g., a centralized or distributed database, and/or associated caches and servers) configured to store the one or more instructions 1024.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1000 and that cause the machine 1000 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., Electrically Programmable Read-Only Memory (EPROM), or Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device/transceiver 1020 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), Plain Old Telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1020 may include one or more physical jacks (e.g., Ethernet, coaxial, or phone jacks) or one or more antennas to connect to the communications network 1026. In an example, the network interface device/transceiver 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1000 and includes digital or analog communications signals or other intangible media to facilitate communication of such software. The operations and processes (e.g., processes 600 and 700) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device”, “user device”, “communication station”, “station”, “handheld device”, “mobile device”, “wireless device” and “user equipment” (UE) as used herein refers to a wireless communication device such as a cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as ‘communicating’, when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter device to transmit the wireless communication signal to at least one other wireless communication unit, and/or a wireless communication receiver device to receive the wireless communication signal from at least one other wireless communication unit.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver device or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

In example embodiments of the disclosure, there may be a device, comprising a memory and processing circuitry configured to: identify a disruption between at least two first beamforming vectors on adjacent frequencies in a communication channel between the device and a first device of a plurality of user devices; determine one or more second beamforming vectors proximate to the identified disruption; and utilize the one or more second beamforming vectors to smooth the communication channel between the device and the first device of the plurality of user devices. The processing circuitry may be further configured to: identify the disruption, based at least in part on a first element, associated with a first beamforming vector of the at least two beamforming vectors, being substantially different from a second element associated with a second beamforming vector of the at least two beamforming vectors. The first element corresponds to a first frequency, the second element corresponds to a second frequency, and the first frequency is less than the second frequency. The first beamforming vector is based at least in part on a first tone of the adjacent frequencies, and the second beamforming vector is based at least in part on a second tone of the adjacent frequencies. The communication channel may be a multiple-input-multiple-output (MIMO) channel. The communication channel may be based at least in part on a beamforming matrix comprising at least two columns. The at least two columns of the beamforming matrix may comprise the at least two first beamforming vectors. The at least two columns of the beamforming matrix may be orthonormal vectors. The processing circuitry may be further configured to: determine the one or more second beamforming vectors based at least in part on a linear combination of the at least two first beamforming vectors by a rotation matrix.

In some example embodiments of the disclosure, there may be a non-transitory computer-readable medium storing computer-executable instructions which, when executed by a processor, cause the processor to perform operations comprising: identifying a disruption between at least two first beamforming vectors on adjacent frequencies in a communication channel with a first device of a plurality of user devices; determining one or more second beamforming vectors proximate to the identified disruption; and utilizing the one or more second beamforming vectors to smooth the communication channel between the device and the first device.

Implementations may include the following features. The processor may execute further computer-executable instructions that cause the processor to perform operations comprising: identifying the disruption, based at least in part on a first element, associated with a first beamforming vector of the at least two beamforming vectors, being substantially different from a second element associated with a second beamforming vector of the at least two beamforming vectors. The first element corresponds to a first frequency, the second element corresponds to a second frequency, and the first frequency is less than the second frequency. The first beamforming vector is based at least in part on a first tone of the adjacent frequencies, and the second beamforming vector is based at least in part on a second tone of the adjacent frequencies. The communication channel may be a multiple-input-multiple-output (MIMO) channel.

The communication channel may be based at least in part on a beamforming matrix comprising at least two columns. The at least two columns of the beamforming matrix may comprise the at least two first beamforming vectors. The at least two columns of the beamforming matrix may be orthonormal vectors.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising:
memory and processing circuitry configured to:
identify a disruption between at least two first beamforming vectors on adjacent frequencies in a communication channel between the device and a first device of a plurality of user devices;
determine one or more second beamforming vectors proximate to the identified disruption; and
utilize the one or more second beamforming vectors to smooth the communication channel between the device and the first device of the plurality of user devices.

2. The wireless device of claim 1, wherein the processing circuitry is further configured to:
identify the disruption, based at least in part on a first element, associated with a first beamforming vector of the at least two beamforming vectors, being substantially different from a second element associated with a second beamforming vector of the at least two beamforming vectors.

3. The wireless device of claim 2, wherein the first element corresponds to a first frequency, the second element corresponds to a second frequency, and the first frequency is less than the second frequency.

4. The wireless device of claim 2, wherein the first beamforming vector is based at least in part on a first tone of the adjacent frequencies, and the second beamforming vector is based at least in part on a second tone of the adjacent frequencies.

5. The wireless device of claim 1, wherein the communication channel is a multiple-input-multiple-output (MIMO) channel.

6. The wireless device of claim 1, wherein the communication channel is based at least in part on a beamforming matrix comprising at least two columns.

7. The wireless device of claim 6, wherein the at least two columns of the beamforming matrix comprise the at least two first beamforming vectors.

8. The wireless device of claim 6, wherein the at least two columns of the beamforming matrix are orthonormal vectors.

9. The wireless device of claim 1, wherein the processing circuitry is further configured to:
determine the one or more second beamforming vectors based at least in part on a linear combination of the at least two first beamforming vectors by a rotation matrix.

10. A non-transitory computer-readable medium storing computer-executable instructions which, when executed by a processor, cause the processor to perform operations comprising:
identifying a disruption between at least two first beamforming vectors on adjacent frequencies in a communication channel between the device and a first device of a plurality of user devices;
determining one or more second beamforming vectors proximate to the identified disruption; and
utilizing the one or more second beamforming vectors to smooth the communication channel between the device and the first device of the plurality of user devices.

11. The non-transitory computer-readable medium of claim 11, wherein the computer-executable instructions cause the processor to further perform operations comprising:
identifying the disruption, based at least in part on a first element, associated with a first beamforming vector of the at least two beamforming vectors, being substantially different from a second element associated with a second beamforming vector of the at least two beamforming vectors.

12. The non-transitory computer-readable medium of claim 12, wherein the first element corresponds to a first frequency, the second element corresponds to a second frequency, and the first frequency is less than the second frequency.

13. The non-transitory computer-readable medium of claim 12, wherein the first beamforming vector is based at least in part on a first tone of the adjacent frequencies, and the second beamforming vector is based at least in part on a second tone of the adjacent frequencies.

14. The non-transitory computer-readable medium of claim 11, wherein the communication channel is a multiple-input-multiple-output (MIMO) channel.

15. The non-transitory computer-readable medium of claim 11, wherein the communication channel is based at least in part on a beamforming matrix comprising at least two columns.

16. The non-transitory computer-readable medium of claim 15, wherein the at least two columns of the beamforming matrix comprise the at least two first beamforming vectors.

17. The non-transitory computer-readable medium of claim 15, wherein the at least two columns of the beamforming matrix are orthonormal vectors.

18. A method comprising:
identifying a disruption between at least two first beamforming vectors on adjacent frequencies in a communication channel between the device and a first device of a plurality of user devices;
determining one or more second beamforming vectors proximate to the identified disruption; and
utilizing the one or more second beamforming vectors to smooth the communication channel between the device and the first device of the plurality of user devices.

19. The method of claim 18, further comprising:
identifying the disruption, based at least in part on a first element, associated with a first beamforming vector of the at least two beamforming vectors, being substantially different from a second element associated with a second beamforming vector of the at least two beamforming vectors.

20. The method of claim 19, wherein the first element corresponds to a first frequency, the second element corresponds to a second frequency, and the first frequency is less than the second frequency.
